(19) United States
(12) Patent Application Publication
(10) Pub. No.: US 2026/0245781 A1
(43) Pub. Date: Aug. 20, 2026

(54) COIL COMPONENT, AND METHOD FOR MANUFACTURING COIL COMPONENT

(71) Applicant: DELTA ELECTRONICS (JAPAN), INC., Tokyo (JP)

(72) Inventors: Mitsuo KAWASAKI, Tokyo (JP); Satoshi MARUYAMA, Tokyo (JP); Takeshi TAKAHASHI, Tokyo (JP); Shuji IGUCHI, Tokyo (JP); Hirofumi IMAI, Tokyo (JP)

(73) Assignee: DELTA ELECTRONICS (JAPAN), INC., Tokyo (JP)

(21) Appl. No.: 19/548,920

(22) Filed: Feb. 24, 2026

Related U.S. Application Data
(63) Continuation of application No. PCT/JP2023/031615, filed on Aug. 30, 2023.

(51) Int. Cl. H01F 17/04; H01F 27/02; H01F 27/29; H01F 41/02; H01F 41/12

(52) U.S. Cl. CPC H01F 17/04; H01F 27/022; H01F 27/027; H01F 27/292; H01F 41/0246; H01F 41/125; H01F 2017/048

(57) ABSTRACT

Coil component includes coil member having annular conductor with central axis along first direction and having two electrical ends, and main body covering the annular conductor with first and second intersecting surfaces aligned in the first direction, and containing binder and binder-held magnetic powder. The coil member has first end surface and second end surface exposed from the main body and respectively connected to one and the other electrical ends of the annular conductor. The first end surface is covered with first external electrode provided on the second intersecting surface, and the second end surface is covered with second external electrode electrically separated from the first external electrode outside the main body and provided on the second intersecting surface. Outer surface located between the first and second intersecting surfaces in the main body has tapered outer surface moving away from the central axis as approaching the first intersecting surface.

### CROSS REFERENCE TO RELATED APPLICATION

This application is a continuation application of PCT Application No. PCT/JP2023/031615, filed on Aug. 30, 2023. The content of the application is incorporated herein by reference.

### BACKGROUND OF THE INVENTION

### 1. Field of the Invention

The present invention relates to a coil component and a method for manufacturing the coil component.

### 2. Description of the Related Art

Patent Document 1 discloses a coil component capable of improving the aspect ratio of each turn of a coil pattern and maintaining the rigidity of a support substrate. The coil component includes a support substrate, a first conductive layer arranged to contact one surface of the support substrate, a coil part including a second conductive layer arranged on the first conductive layer so as to be separated from the one surface of the support substrate, and a main body in which the support substrate and the coil part are embedded, wherein one side surface of the first conductive layer is arranged closer to the center in the width direction of the second conductive layer than one side surface of the second conductive layer.

Patent Document 2 discloses a method for manufacturing a common mode filter. The manufacturing method can include a step of applying electrolytic plating to a first coil pattern made of a conductive material to form a second coil pattern having a larger cross-sectional area than the first coil pattern, and can realize a common mode filter satisfying the demand for miniaturization and having improved characteristics such as inductance and DC resistance.

### PRIOR ART DOCUMENT

### Patent Document

[Patent Document 1] Japanese Patent Publication No. 2021-034715

[Patent Document 2] Japanese Patent Publication No. 2013-197588

### SUMMARY OF THE INVENTION

### Problems to be Solved by the Invention

When a coil component is mounted on a substrate, an electrode provided on the substrate and a first external electrode or a second external electrode of the coil component are joined via a solder fillet provided on the electrode. Here, the solder melted from the fillet during reflow wets up the outer surface, increasing the contact area between the solder and the coil component, and resulting in an improvement in conductivity and adhesion between the coil component and the electrode. In order to appropriately secure the wetting up, it is preferable that the electrode extends outside the coil component and the solder appropriately wets and spreads on the extended portion. However, the existence of the extended portion has been an obstacle from the viewpoint of realizing high-density mounting. In addition, when manufacturing a small coil component, it is important to improve productivity while reducing the processing load in order to efficiently manufacture a highly reliable coil component.

An object of the present invention is to feasibly provide a coil component with high-density mounting and improved connection reliability, and a method for manufacturing a coil component with improved productivity.

### Means to Solve the Problems

A coil component according to one aspect of the present invention includes: a coil member including an annular conductor portion, which has a central axis along a first direction and includes two electrical ends; and a main body portion covering the annular conductor portion with a first intersecting surface and a second intersecting surface aligned in the first direction, and including a binder and a magnetic powder held by the binder. The coil member has a first end surface exposed from a surface of the main body portion and connected to one of the two electrical ends of the annular conductor portion, and a second end surface exposed from the surface of the main body portion and connected to the other of the two electrical ends of the annular conductor portion. The first end surface is covered with a first external electrode having a portion provided on the second intersecting surface. The second end surface is covered with a second external electrode, which is electrically separated from the first external electrode outside the main body portion and has a portion provided on the second intersecting surface. An outer surface located between the first intersecting surface and the second intersecting surface of the main body portion has a tapered outer surface that moves further away from the central axis as it approaches the first intersecting surface.

In this way, by providing the tapered outer surface on the outer surface of the main body portion, the area of the second intersecting surface side of the main body portion, which is the mounting surface side of the coil component, becomes smaller than the area of the opposite side (the first intersecting surface side of the main body portion). As a result, the mounting area of the coil component can be reduced without reducing the area of the electrodes of the coil component.

In the above coil component, each of the first external electrode and the second external electrode may extend so as to at least partially cover the tapered outer surface. If the external electrode is provided on the tapered outer surface, the solder preferentially wets up the tapered outer surface, so that the adhesion of the coil component to the solder can be more stably improved.

In the above coil component, the tapered outer surface may have a most distal portion located farthest from the central axis in the main body portion. By locating the most distal portion of the main body portion on the tapered outer surface in this manner, the mounting area of the coil component after mounting becomes smaller than when the most distal portion is located at the boundary with the first intersecting surface. Moreover, since a portion relatively distal from the central axis is excluded as the portion to be removed from the main body portion, the influence on the magnetic characteristics is small.

In the above coil component, the surface roughness of the most distal portion may be greater than the surface roughness of other portions of the tapered outer surface, and each of the first external electrode and the second external electrode may extend so as to at least partially cover the most distal portion. This improves the adhesion of the first external electrode and the second external electrode at least partially covering the most distal portion.

In the above coil component, at least one of the first end surface and the second end surface may have a portion exposed from the tapered outer surface. Since the external electrode is positioned on the tapered outer surface, the conductivity of the external electrode is improved, and the adhesion with the solder is improved.

In the above coil component, at least a portion of the first end surface may be exposed from the second intersecting surface, and at least a portion of the second end surface may be exposed from a portion on the second intersecting surface different from a portion where the at least a portion of the first end surface is exposed. Thereby, conduction between the annular conductor portion and the first external electrode and the second external electrode is established on the second intersecting surface.

In the above coil component, the tapered outer surface may have a portion formed from a surface relatively rich in processing marks in the first direction. Since such a surface has processing marks, its surface roughness is higher than that of a molded surface where the entire object is pressurized using a mold. Therefore, the adhesion of members positioned to cover the surface relatively rich in processing marks in the first direction increases.

In the above coil component, the magnetic powder may be made of a metallic material, and a cut surface of the magnetic powder may not be located on the surface relatively rich in processing marks in the first direction. Thereby, even when the magnetic powder includes a portion made of a metallic material, corrosion is less likely to occur.

A coil component according to another aspect of the present invention includes: a coil member including an annular conductor portion, which has a central axis along a first direction and includes two electrical ends; and a main body portion covering the annular conductor portion with a first intersecting surface and a second intersecting surface aligned in the first direction, and including a magnetic powder having a portion made of a metallic material, and a binder. An outer surface located between the first intersecting surface and the second intersecting surface of the main body portion has a surface relatively rich in processing marks having a component in the first direction, and a cut surface of the magnetic powder is not located on the surface relatively rich in processing marks in the first direction.

Thereby, even when the magnetic powder includes a portion made of a metallic material, corrosion is less likely to occur.

In the above coil component, the binder may contain a cured material of a curable resin, and the magnetic powder may be subjected to a surface insulation treatment.

A method for manufacturing a coil component according to a further aspect of the present invention is a method for manufacturing a coil component. The coil component includes a coil member including an annular conductor portion, which has a central axis along a first direction and includes two electrical ends, and a main body portion covering the annular conductor portion with a first intersecting surface and a second intersecting surface aligned in the first direction, and including a binder and a magnetic powder held by the binder. The method includes: forming a first intermediate member including a first member containing a semi-cured material of the binder and the magnetic powder, and the coil member having a portion embedded in the first member; performing at least one of a slit forming process and a groove forming process on the first intermediate member to form a second intermediate member; and forming a third intermediate member, which includes performing a curing process to cure the semi-cured material included in the second intermediate member into the binder.

In the present specification, the slit forming process refers to a process of forming a slit penetrating in the first direction in the intermediate member, and the groove forming process refers to a process of forming a groove not penetrating in the first direction in the intermediate member. According to the configuration, by processing the first intermediate member containing the semi-cured material that is relatively soft compared to the binder, the processing load is alleviated, and an improvement in coil component productivity, such as an extension of tool life, is realized.

In the above method for manufacturing a coil component, the second intermediate member may be formed by performing at least the groove forming process on the first intermediate member, and a breaking process of breaking from a surface formed by the groove forming process may be performed on the third intermediate member. Thereby, the breaking process is performed starting from a part of the groove formed in the third intermediate member, and the third intermediate member is divided.

In the above method for manufacturing a coil component, the second intermediate member may be formed by performing the slit forming process and the groove forming process on the first intermediate member. When the first intermediate member has a large number of coil members, dividing the member to be broken to some extent before the breaking process simplifies the subsequent steps and improves the productivity of the coil component. Regarding the division, rather than applying a slit forming process to the third intermediate member containing the binder formed by curing the semi-cured material, applying not only the groove forming process but also the slit forming process to the first intermediate member containing the semi-cured material for division is expected to extend the life of the tool used for the slit forming process.

In the above method for manufacturing a coil component, the breaking process may be performed after performing the slit forming process on the third intermediate member. When the first intermediate member includes a large number of coil members, dividing the cured third intermediate member before proceeding with the subsequent steps may improve the dimensional accuracy after processing. Since improvement in dimensional accuracy after processing leads to a decrease in the incidence of defective products, the productivity of the coil component is improved.

In the above method for manufacturing a coil component, the first member and one or more coil members may be placed in a cavity of a mold provided with at least one of a tool for the slit forming process and a tool for the groove forming process, and the process of forming the first intermediate member and at least one of the slit forming process and the groove forming process may be performed in a single step to form the second intermediate member. This allows the second intermediate member to be formed without a step of handling the first intermediate member, reducing the total number of steps and improving the productivity of the coil component.

In the above method for manufacturing a coil component, the second intermediate member may be formed by performing the slit forming process on the first intermediate member, and the slit forming process may be performed on the third intermediate member. In this case, even if the first intermediate member has a large number of coils, since the second intermediate member is obtained by dividing the first intermediate member to some extent, the subsequent steps are simplified, and the productivity of the coil component is improved. Also, since the division is performed prior to curing, the life of the dividing tool is extended, which also improves the productivity of the coil component.

In the above method for manufacturing a coil component, an outer cover processing may be applied to the third intermediate member before the processing to divide the third intermediate member. Since surfaces other than those formed by dividing the third intermediate member are covered with the outer cover, the manufacturing process is simplified and the productivity of the coil component is improved.

In the above method for manufacturing a coil component, in the groove forming process, the processing may be performed from both a side corresponding to the first intersecting surface and a side corresponding to the second intersecting surface of the first intermediate member. Since the groove forming process is applied from both the first intersecting surface side and the second intersecting surface side in this way, the process of dividing the third intermediate member, particularly the breaking process, becomes easier, and the productivity of the coil component is improved.

In the above method for manufacturing a coil component, the processing to divide the third intermediate member may be performed, and an outer cover processing to apply an outer cover to the member obtained by the processing may be performed. By doing this, the outer cover is applied to a wide range of exposed surfaces of the member obtained by dividing the third intermediate member.

### Effects of the Invention

According to the present invention, a coil component with high-density mounting and improved connection reliability is provided. In addition, according to the present invention, a method for manufacturing a coil component with improved productivity based on extended tool life and simplified processes is provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view conceptually illustrating the shape of a coil component according to an embodiment of the present invention.

FIG. 2 is a diagram illustrating the structure of a coil conductor portion provided in the coil component according to an embodiment of the present invention.

FIG. 3 is an XY plan view illustrating the structure of a first spiral conductor portion provided in the coil component according to an embodiment of the present invention.

FIG. 4 is an XY plan view illustrating the structure of a second spiral conductor portion provided in the coil component according to an embodiment of the present invention.

FIG. 5 is a cross-sectional view illustrating the structure of a coil member provided in the coil component according to an embodiment of the present invention.

FIG. 6 is a cross-sectional view illustrating the structure of a coil member provided in the coil component according to an embodiment of the present invention.

FIG. 7A is a schematic diagram illustrating a state in which the coil component is mounted on a substrate.

FIG. 7B is a schematic diagram illustrating a state in which the coil component is mounted on a substrate.

FIG. 8 is a cross-sectional view illustrating a coil component according to a second embodiment.

FIG. 9 is a cross-sectional view illustrating a coil component according to a third embodiment.

FIG. 10 is a cross-sectional view illustrating a coil component according to a fourth embodiment.

FIG. 11A is a diagram illustrating a first method for manufacturing a coil component (showing a state that coil conductor portions are formed on a sheet substrate).

FIG. 11B is a diagram illustrating the first method for manufacturing a coil component (showing a state that a part of the sheet substrate is removed to form a coil array sheet).

FIG. 11C is a diagram illustrating the first method for manufacturing a coil component (cross-sectional view taken along line C-C′ of FIG. 11B).

FIG. 12A is a diagram illustrating the first method for manufacturing a coil component (showing a state that constituent materials of a first member are placed in a mold).

FIG. 12B is a diagram illustrating the first method for manufacturing a coil component (showing a state that pressurization of the constituent materials of the first member in the mold is started).

FIG. 12C is a diagram illustrating the first method for manufacturing a coil component (showing a state that the first member is formed in the mold).

FIG. 13A is a diagram illustrating the first method for manufacturing a coil component (showing a state that the first member and the coil array sheet are placed in a mold).

FIG. 13B is a diagram illustrating the first method for manufacturing a coil component (showing a state that a first intermediate member is formed in the mold).

FIG. 13C is a diagram illustrating the first method for manufacturing a coil component (showing the first intermediate member taken out from the mold).

FIG. 14 is a diagram illustrating the first method for manufacturing a coil component (showing a state that a slit forming process is performed on the first intermediate member to form a second intermediate member).

FIG. 15A is a diagram illustrating the first method for manufacturing a coil component (cross-sectional view taken along line D-D′ of FIG. 14).

FIG. 15B is a diagram illustrating the first method for manufacturing a coil component (cross-sectional view taken along line E-E′ of FIG. 14).

FIG. 16A is a diagram illustrating the first method for manufacturing a coil component (showing a state that an outer cover processing is applied to a third intermediate member).

FIG. 16B is a diagram illustrating the first method for manufacturing a coil component (showing a state that an outer cover processing is applied to a third intermediate member).

FIG. 17 is a diagram illustrating the first method for manufacturing a coil component (showing a state that the third intermediate member is divided to form coil component materials).

FIG. 18A is a diagram illustrating the first method for manufacturing a coil component (cross-sectional view taken along line D-D′ of FIG. 17).

FIG. 18B is a diagram illustrating the first method for manufacturing a coil component (cross-sectional view taken along line E-E′ of FIG. 17).

FIG. 19 is a diagram illustrating the first method for manufacturing a coil component (showing a coil component obtained by forming a first terminal member and a second terminal member on the coil component material).

FIG. 20A is a diagram illustrating a second method for manufacturing a coil component (showing a state that the first member and the coil array sheet are placed in a mold).

FIG. 20B is a diagram illustrating the second method for manufacturing a coil component (showing a state that the second intermediate member is formed in the mold).

FIG. 21 is a diagram illustrating the second method for manufacturing a coil component (showing the second intermediate member taken out from the mold).

FIG. 22A is a diagram illustrating the second method for manufacturing a coil component (cross-sectional view taken along line D-D′ of FIG. 21).

FIG. 22B is a diagram illustrating the second method for manufacturing a coil component (cross-sectional view taken along line E-E′ of FIG. 21).

FIG. 23 is a diagram illustrating the second method for manufacturing a coil component (showing a state that a slit forming process is performed on the second intermediate member having grooves).

FIG. 24A is a diagram illustrating the second method for manufacturing a coil component (cross-sectional view taken along line D-D′ of FIG. 23).

FIG. 24B is a diagram illustrating the second method for manufacturing a coil component (cross-sectional view taken along line E-E′ of FIG. 23).

FIG. 25A is a diagram illustrating the second method for manufacturing a coil component (showing a state that an outer cover processing is applied to the third intermediate member).

FIG. 25B is a diagram illustrating the second method for manufacturing a coil component (showing a state that an outer cover processing is applied to the third intermediate member).

FIG. 26A is a diagram illustrating the second method for manufacturing a coil component (showing a state that a breaking process is performed on the third intermediate member to form coil component materials).

FIG. 26B is a diagram illustrating the second method for manufacturing a coil component (showing a coil component obtained by forming a first terminal member and a second terminal member on the coil component material).

FIG. 26C is a diagram illustrating a second modification example of the second method for manufacturing a coil component (showing a state that a blade tool for performing a groove forming process on the first intermediate member is arranged).

FIG. 26D is a diagram illustrating the second modification example of the second method for manufacturing a coil component (showing a state that the groove forming process is performed on the first intermediate member to form the second intermediate member).

FIG. 26E is a diagram illustrating the second modification example of the second method for manufacturing a coil component (showing a state that the blade tool is separated from the second intermediate member).

FIG. 27A is a schematic perspective view illustrating the state of a surface formed by a groove forming process and a surface formed by a breaking process.

FIG. 27B is a schematic cross-sectional view illustrating the state of a surface formed by a breaking process.

FIG. 27C is a schematic cross-sectional view illustrating the state of cutting.

FIG. 28A is a diagram illustrating a third method for manufacturing a coil component (showing a state that the first member and the coil array sheet are placed in a mold).

FIG. 28B is a diagram illustrating the third method for manufacturing a coil component (showing a state that the second intermediate member is formed in the mold).

FIG. 28C is a diagram illustrating the third method for manufacturing a coil component (showing the second intermediate member taken out from the mold).

FIG. 29A is a diagram illustrating the third method for manufacturing a coil component (showing a state that a breaking process is performed on the third intermediate member to form coil component materials).

FIG. 29B is a diagram illustrating the third method for manufacturing a coil component (showing a state that a coil component obtained by forming a first terminal member and a second terminal member on the coil component material is obtained).

FIG. 30A is a diagram illustrating a fourth method for manufacturing a coil component (showing a state that the first member and the coil array sheet are placed in a mold).

FIG. 30B is a diagram illustrating the fourth method for manufacturing a coil component (showing a state that the second intermediate member is formed in the mold).

FIG. 31 is a diagram illustrating the fourth method for manufacturing a coil component (showing the second intermediate member taken out from the mold).

FIG. 32A is a diagram illustrating the fourth method for manufacturing a coil component (cross-sectional view taken along line D-D′ of FIG. 31).

FIG. 32B is a diagram illustrating the fourth method for manufacturing a coil component (cross-sectional view taken along line E-E′ of FIG. 31).

FIG. 33 is a diagram illustrating the fourth method for manufacturing a coil component (showing a state that a slit forming process is performed on the second intermediate member having grooves).

FIG. 34A is a diagram illustrating the fourth method for manufacturing a coil component (cross-sectional view taken along line D-D′ of FIG. 33).

FIG. 34B is a diagram illustrating the fourth method for manufacturing a coil component (cross-sectional view taken along line E-E′ of FIG. 33).

FIG. 35A is a diagram illustrating the fourth method for manufacturing a coil component (showing a state that an outer cover processing is applied to the third intermediate member).

FIG. 35B is a diagram illustrating the fourth method for manufacturing a coil component (showing a state that an outer cover processing is applied to the third intermediate member).

FIG. 36A is a diagram illustrating the fourth method for manufacturing a coil component (showing a state that a breaking process is performed on the third intermediate member to form coil component materials).

FIG. 36B is a diagram illustrating the fourth method for manufacturing a coil component (showing a coil component obtained by forming a first terminal member and a second terminal member on the coil component material).

FIG. 37 is a diagram illustrating a fifth method for manufacturing a coil component (showing a state that a slit forming process by push-cutting is performed on the first intermediate member to form the second intermediate member).

FIG. 38A is a diagram illustrating the fifth method for manufacturing a coil component (cross-sectional view taken along line D-D′ of FIG. 37).

FIG. 38B is a diagram illustrating the fifth method for manufacturing a coil component (cross-sectional view taken along line E-E′ of FIG. 37).

FIG. 39A is a diagram illustrating the fifth method for manufacturing a coil component (showing a state that an outer cover processing is applied to the third intermediate member).

FIG. 39B is a diagram illustrating the fifth method for manufacturing a coil component (showing a state that an outer cover processing is applied to the third intermediate member).

FIG. 40 is a diagram illustrating the fifth method for manufacturing a coil component (showing a state that the third intermediate member is divided to form coil component materials).

FIG. 41A is a diagram illustrating the fifth method for manufacturing a coil component (cross-sectional view taken along line D-D′ of FIG. 40).

FIG. 41B is a diagram illustrating the fifth method for manufacturing a coil component (cross-sectional view taken along line E-E′ of FIG. 40).

FIG. 42A is a diagram illustrating the fifth method for manufacturing a coil component (a coil component obtained by forming a first terminal member and a second terminal member on the coil component material).

FIG. 42B is a diagram illustrating the fifth method for manufacturing a coil component (showing a state that an outer cover processing is applied to a surface formed when the third intermediate member is divided).

### DETAILED DESCRIPTION

Hereinafter, embodiments of the present invention will be described in detail with reference to the drawings.

### First Embodiment

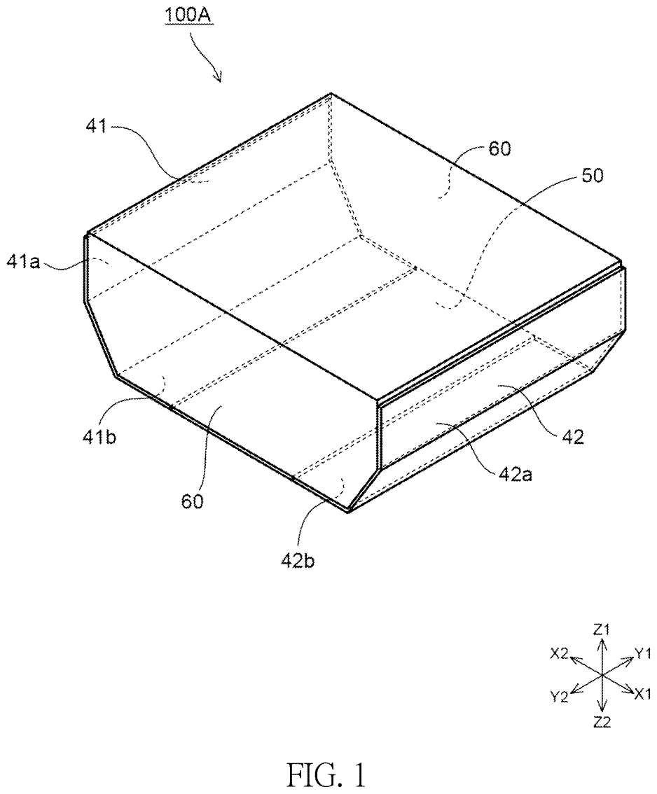

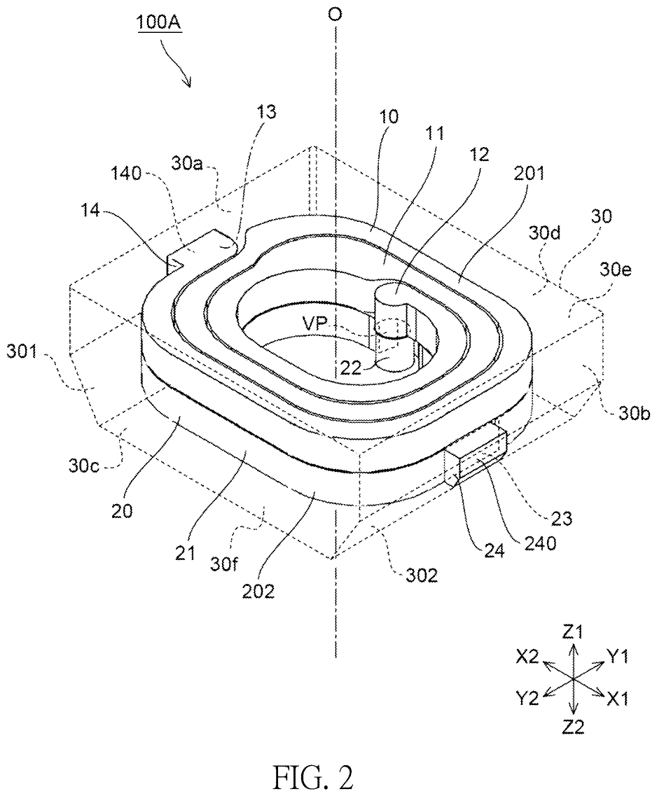

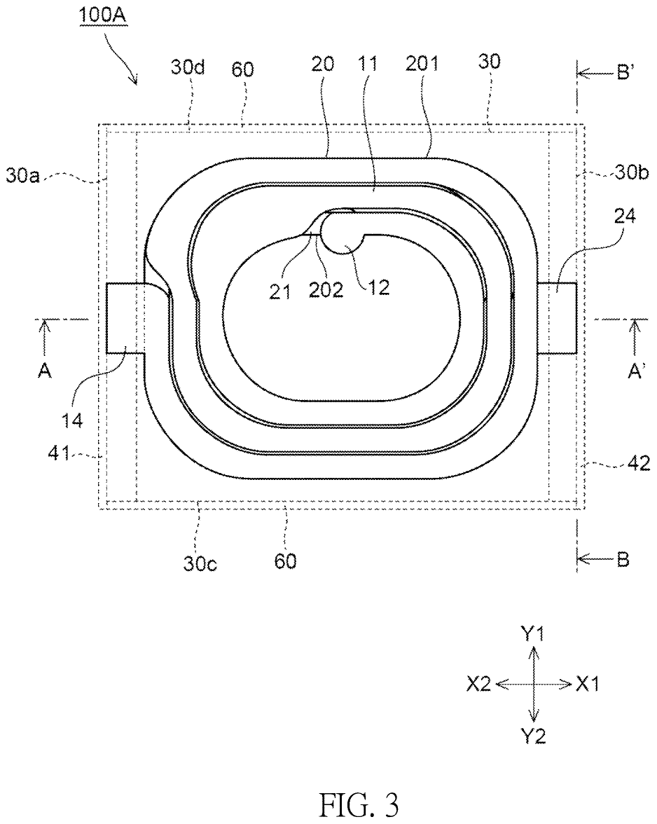

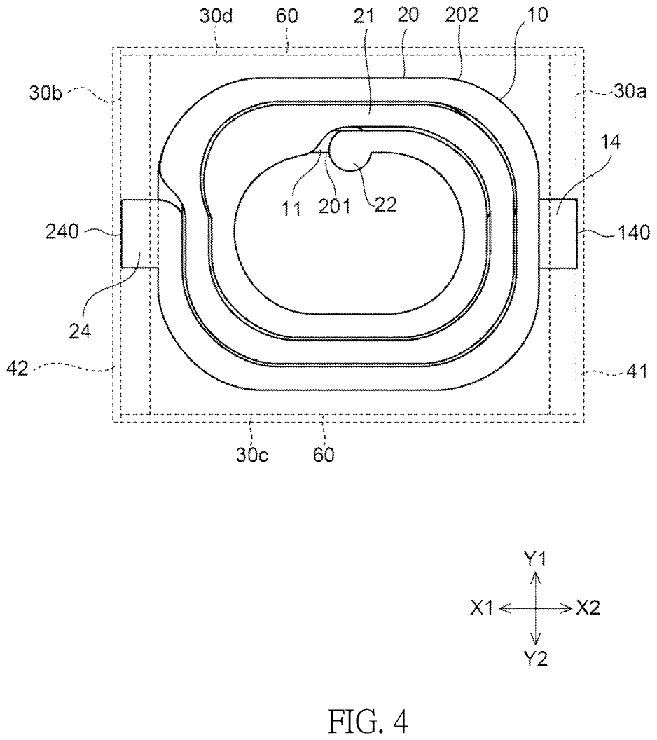

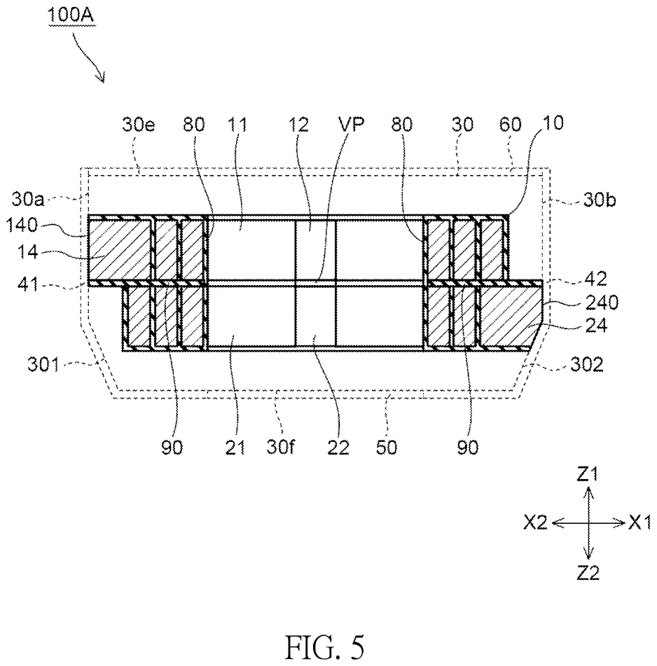

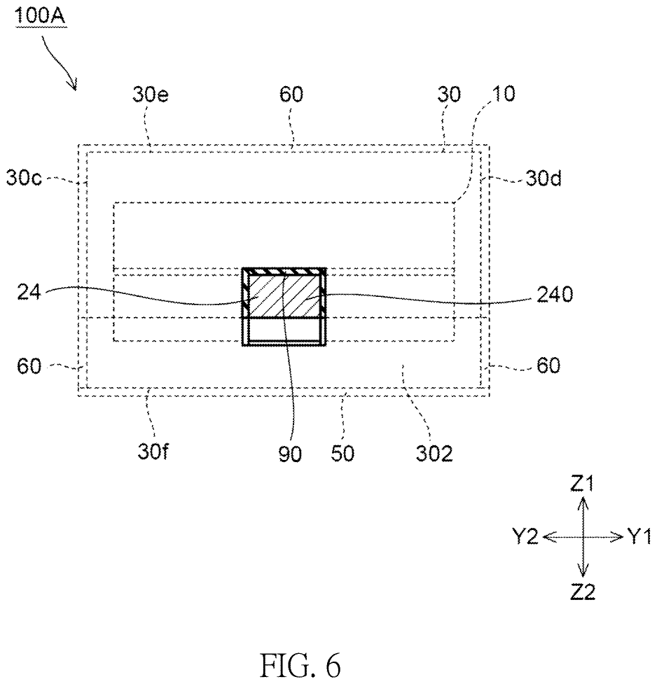

FIG. 1 is a perspective view conceptually illustrating the shape of a coil component according to an embodiment of the present invention. FIG. 2 is a diagram illustrating the structure of a coil conductor portion provided in the coil component according to an embodiment of the present invention. In FIG. 2, for convenience of explanation, the coil conductor portion is drawn with solid lines, the main body portion is drawn with broken lines, and the display of other components is omitted. FIG. 3 is an XY plan view illustrating the structure of a first spiral conductor portion provided in the coil component according to an embodiment of the present invention. FIG. 4 is an XY plan view illustrating the structure of a second spiral conductor portion provided in the coil component according to an embodiment of the present invention. FIG. 5 and FIG. 6 are cross-sectional views illustrating the structure of a coil member provided in the coil component according to an embodiment of the present invention. Note that FIG. 2 is a view from the Z1 side in the Z1-Z2 direction. FIG. 3 is a plan view from the Z1 side in the Z1-Z2 direction, where the coil conductor portion is drawn with solid lines and the other parts with broken lines. FIG. 4 is a plan view from the Z2 side in the Z1-Z2 direction, where the coil conductor portion is drawn with solid lines and the other parts with broken lines. In FIG. 5, the main body portion, the terminal members, and the outer cover are indicated by broken lines, and a cross section taken along line A-A′ in FIG. 3 is shown as an XZ cross-sectional view. In FIG. 6, the main body portion and the outer cover are indicated by broken lines, and a cross section taken along line B-B′ in FIG. 3 is shown as a YZ cross-sectional view.

### (Overall Configuration)

As shown in FIG. 1 and FIG. 2, a coil component 100A according to an embodiment of the present invention includes a coil member 10 having a coil conductor portion 20 which is an example of an annular conductor portion, a main body portion 30, a first terminal member 41, a second terminal member 42, and outer covers 50 and 60.

### (Coil)

As shown in FIG. 2 and FIG. 3, the coil member 10 has a coil conductor portion 20 including a first coil conductor portion 201 having a first spiral conductor portion 11. The first spiral conductor portion 11 has a spiral shape around a central axis O extending away from the central axis O along a first direction (Z1-Z2 direction) from an inner-side end part 12, which is one end part of a pair of end parts of the first spiral conductor portion 11 on the inner peripheral side, toward an outer-side end part 13, which is the other end part of the pair of end parts of the first spiral conductor portion 11 on the outer peripheral side. In FIG. 2, as viewed from the Z1 side in the Z1-Z2 direction, the first spiral conductor portion 11 has its conductor arranged in a spiral shape that moves away from the central axis O in a clockwise direction from the inner-side end part 12 toward the outer-side end part 13. In this specification, the “spiral direction” in the spiral portions (first spiral conductor portion 11 and second spiral conductor portion 21) indicates the direction from the end part on the inner peripheral side to the end part on the outer peripheral side. Further, “viewed in the first direction” means it may be viewed from the Z1 side in the Z1-Z2 direction, or it may be viewed from the Z2 side in the Z1-Z2 direction.

The conductor (conductive material) constituting the coil conductor portion 20 is not limited as long as it has an appropriate electrical conductivity. Metals such as copper, copper alloys, aluminum, and aluminum alloys can be cited as specific examples of the conductor constituting the coil conductor portion 20, and the coil conductor portion 20 can be manufactured using a film-forming technique such as plating. The coil member 10 has an insulating coil insulator portion (not shown in FIG. 1 to FIG. 4) on the surface of the coil conductor portion 20. Insulation between adjacent conductors (between the surfaces of conductors facing each other) in the coil conductor portion 20 is ensured by the coil insulator portion. The coil insulator portion includes, for example, a resin material. No coil insulator portion is provided on the terminals (first lead-out exposed surface 140, second lead-out exposed surface 240) of the two end parts (first lead-out portion 14, second lead-out portion 24) as the coil conductor portion 20, and the coil member 10 can be electrically connected to other members at these terminals.

As shown in FIG. 2 and FIG. 4, the coil conductor portion 20 includes a second coil conductor portion 202 having a second spiral conductor portion 21 disposed alongside the first spiral conductor portion 11 in the first direction. The second spiral conductor portion 21 has a spiral shape around the central axis O, extending away from the central axis O along the first direction (Z1-Z2 direction) from one end part (inner-side end part 22), which is an end part of the second spiral conductor portion 21 on the inner peripheral side, toward the other end part (outer-side end part 23), which is an end part of the second spiral conductor portion 21 on the outer peripheral side. In the second spiral conductor portion 21, as viewed from the Z1 side in the Z1-Z2 direction, the conductor is arranged in a spiral shape that moves away from the central axis O in a direction opposite to that of the first spiral conductor portion 11 (counterclockwise in FIG. 2).

The average clearance between the first spiral conductor portion 11 and the second spiral conductor portion 21 in the first direction (Z1-Z2 direction) is not particularly limited. The smaller the clearance is, the easier it is to reduce the height (dimension in the Z1-Z2 direction) of the coil component 100A, but if it is excessively small, the insulation between the first spiral conductor portion 11 and the second spiral conductor portion 21 tends to decrease. From the viewpoint of achieving both a low profile (low height) as the coil component 100A and high insulation between the first spiral conductor portion 11 and the second spiral conductor portion 21, it may be preferable that the clearance is 0.4 μm or more and 20 μm or less. The clearance is more preferably 1.0 μm or more, and further preferably 5.0 μm or more, in terms of manufacturing, in order to reduce variations in the clearance and to more reliably secure support in the same plane of the coil.

The inner-side end part 12, which is one end of the first spiral conductor portion 11, and the inner-side end part 22, which is one end of the second spiral conductor portion 21, are electrically connected by a via part VP. Starting from the connection portion to the via part VP, the first spiral conductor portion 11 and the second spiral conductor portion 21 spiral in mutually opposite directions. The via part VP may be composed of the same conductor as the coil conductor portion 20. In a specific example, the via part VP is made of the same material as the first spiral conductor portion 11 and the second spiral conductor portion 21, and is manufactured simultaneously with the first spiral conductor portion 11 and the second spiral conductor portion 21. In this case, the via part VP is integrated with the inner-side end part 12 at one side of the first spiral conductor portion 11 and the inner-side end part 22 at one side of the second spiral conductor portion 21.

The first lead-out portion 14 is provided contiguously with the outer-side end part 13, which is the other end of the first spiral conductor portion 11, as a part of the first coil conductor portion 201, and a second lead-out portion 24 is provided contiguously with the outer-side end part 23, which is the other end of the second spiral conductor portion 21, as a part of the second coil conductor portion 202. Therefore, the outer-side end part 13 of the first spiral conductor portion 11 is substantially an interface with the first lead-out portion 14, and the outer-side end part 23 of the second spiral conductor portion 21 is substantially an interface with the second lead-out portion 24. In a specific example, the first lead-out portion 14 and the second lead-out portion 24 are made of the same material as the first spiral conductor portion 11 and the second spiral conductor portion 21, and are manufactured simultaneously with the first spiral conductor portion 11 and the second spiral conductor portion 21. That is, the first coil conductor portion 201 is manufactured as an integrated unit, and the second coil conductor portion 202 is also manufactured as an integrated unit. In this case, the first lead-out portion 14 is integrated seamlessly with the outer-side end part 13 of the first spiral conductor portion 11, and the second lead-out portion 24 is integrated seamlessly with the outer-side end part 23 of the second spiral conductor portion 21.

That is, in the present embodiment, the coil conductor portion 20, which is an example of the annular conductor portion, has the first coil conductor portion 201 including the first spiral conductor portion 11 and the first lead-out portion 14, the second coil conductor portion 202 including the second spiral conductor portion 21 and the second lead-out portion 24, and the via part VP thereof formed of a common conductive material. The two outer-side end parts 13 and 23 of the coil conductor portion 20 correspond to two electrical ends of the annular conductor portion. As shown in FIG. 3 and FIG. 4, each turn of the first spiral conductor portion 11 and each turn of the second spiral conductor portion 21 are positioned so as to be aligned in the first direction (Z1-Z2 direction).

### (Main Body Portion)

The main body portion 30 contains a binder and a magnetic powder held by the binder, and has outer surfaces 30a, 30b, 30c, and 30d extending in the first direction, and a first intersecting surface 30e and a second intersecting surface 30f as a pair of intersecting surfaces aligned in the first direction. The main body portion 30 covers at least a portion of the coil member 10 with the first intersecting surface 30e and the second intersecting surface 30f.

In this embodiment, the main body portion 30 is formed with the outer surfaces 30a, 30b, 30c, and 30d located between the first intersecting surface 30e and the second intersecting surface 30f, and at least partially the outer surfaces 30a, 30b have tapered outer surfaces 301, 302. The tapered outer surfaces 301, 302 are surfaces that move further away from the central axis O as they approach the first intersecting surface 30e.

The outer surfaces 30a, 30b, 30c, 30d, the first intersecting surface 30e, and the second intersecting surface 30f forming the main body portion 30 are referred to as the surfaces of the main body portion 30. Moreover, the main body portion 30 encloses parts located at the ends of the coil member 10, other than the surface of the first lead-out portion 14 at the outermost end (X2 side in X1-X2 direction) and the surface of the second lead-out portion 24 at the outermost end (X1 side in X1-X2 direction). The first lead-out portion 14 has a first lead-out exposed surface 140 exposed from the surface of the main body portion 30, and the first lead-out exposed surface 140 is a first end surface exposed from the surface of the main body portion 30 in the coil member 10 and electrically connected to the outer-side end part 13, which is one electrical end of an annular conductor portion, i.e., the coil conductor portion 20. The second lead-out portion 24 has a second lead-out exposed surface 240 exposed from the surface of the main body portion 30, and the second lead-out exposed surface 240 is a second end surface exposed from the surface of the main body portion 30 in the coil member 10 and electrically connected to the outer-side end part 23, which is the other electrical end of the annular conductor portion, i.e., the coil conductor portion 20.

The structure of the magnetic powder is not limited. The structure may include a crystalline phase or may include an amorphous phase. Here, a crystalline material is defined as a material composed of a crystalline phase, an amorphous material is defined as a material composed of an amorphous phase, and a composite material is defined as a material composed of a crystalline phase and an amorphous material. If a diffraction spectrum obtained by a general X-ray diffraction method includes sharp diffraction peaks capable of identifying the type of crystalline phase, the material contains a crystalline phase. In addition, if a diffraction spectrum obtained by a general X-ray diffraction method includes a broad peak indicating an amorphous phase, the material contains an amorphous phase. If a DSC curve obtained by differential thermal analysis includes a peak indicating crystallization, that is, an exotherm associated with a phase change from an amorphous phase to a crystalline phase, the material also contains an amorphous phase.

The material system of the magnetic powder is not limited. Specific examples of crystalline materials include Fe—Si—Cr based alloys, Fe—Ni based alloys, Fe—Co based alloys, Fe—V based alloys, Fe—Al based alloys, Fe—Si based alloys, Fe—Si—Al based alloys, pure iron, and ferrite. As pure iron powder, carbonyl iron powder is preferable. Specific examples of amorphous materials include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. When the magnetic powder is a metal powder containing Fe, the synergistic effect of improving magnetic properties is particularly large.

The chemical composition of the magnetic powder is not limited. For example, an Fe—Si—Cr based alloy may consist of 1.0 to 10.0 mass % of Si, 1.0 to 10.0 mass % of Cr, and the balance consisting of Fe and impurities. Also, for example, an Fe—Ni based alloy may consist of 1.0 to 99.0 mass% of Ni, and the balance consisting of Fe and impurities. Further, for example, an Fe—P—C based alloy may consist of 1.0 to 13.0 atomic % of P, 1.0 to 13.0 atomic % of C, and the balance consisting of Fe and impurities. The Fe—P—C based alloy may contain one or more selected from the group consisting of Ni, Sn, Cr, B, and Si as optional elements. In this case, for example, the amount of Ni may be 0 to 10.0 atomic %, the amount of Sn may be 0 to 3.0 atomic %, the amount of Cr may be 0 to 6.0 atomic %, the amount of B may be 0 to 9.0 atomic %, and the amount of Si may be 0 to 7.0 atomic %. The amount of Fe is preferably 65 atomic % or more. Also, for example, an Fe—Si—B—Nb—Cu based alloy may consist of 1.0 to 16.0 atomic % of Si, 1.0 to 15.0 atomic % of B, 0.50 to 5.0 atomic % of Nb, 0.50 to 5.0 atomic % of Cu, and the balance consisting of Fe and impurities. In this case, the amount of Fe is preferably 65 atomic % or more.

The shape of the magnetic powder is not limited. The magnetic powder may be spherical, elliptical, flaky, or have an irregular shape. The manufacturing method to obtain these shapes is also not limited.

The particle size distribution of the magnetic powder is not limited. The particle size distribution of the magnetic powder can be obtained, for example, by analyzing an image (secondary electron image) obtained by capturing a cross section of the main body portion 30 with a scanning electron microscope. For example, the average circle equivalent diameter of the magnetic powder may be 0.50 to 50.0 μm. The distribution of the circle equivalent diameter may include a plurality of peaks.

The magnetic powder may be subjected to a surface insulation treatment. When the magnetic powder is subjected to a surface insulation treatment, the insulation resistance of the main body portion 30 is improved. The type of surface insulation treatment applied to the magnetic powder is not limited. Phosphoric acid treatment, phosphate treatment, oxidation treatment, etc. are exemplified. The magnetic powder may have an insulating coating on the surface of the magnetic particles. The insulating coating may contain at least one selected from the group consisting of Si, P, and B, and O (oxygen).

The magnetic powder may be a mixed material in which a plurality of powder materials are mixed. The magnetic powder is preferably a ferromagnetic material, and more preferably a soft magnetic material.

The binder provided in the main body portion 30 binds particles such as the magnetic powder contained in the main body portion 30 to each other. The binder is preferably an insulating material in order to impart insulation resistance to the main body portion 30.

The material constituting the binder may be an organic material, an inorganic material, or a mixed material of an organic material and an inorganic material. The organic material may be a resin material. Examples of resin materials include acrylic resins, silicone resins, epoxy resins, phenol resins, urea resins, melamine resins, polyester resins, and the like. Examples of inorganic materials include glass-based materials such as water glass.

The material constituting the binder may be a cured material of a curable material that can be cured by heating or the like, and in this case, it may be preferable that the degree of curing of the curable material can be brought to a semi-cured material state (so-called B-stage state) which is lower than that of the binder and has plasticity. From this point of view, the curable material preferably contains an organic material, and more preferably is composed of a plurality of materials having different curing start temperatures. Therefore, in the present specification, a curable material composed of an organic material includes not only a monomer of a resin material but also the concept of a curing agent such as an amine compound or an acid anhydride in an epoxy resin, or a crosslinking agent such as a polyisocyanate compound or a compound containing polyvalent metal ions.

The dimensions of the main body portion 30 are not limited. For example, the maximum dimension of the main body portion 30 may be 3.2 mm or less.

### (External Electrode)

As shown in FIG. 2, the surface (first lead-out exposed surface 140) of the first lead-out portion 14 at the outermost end (X2 side in X1-X2 direction) and the surface (second lead-out exposed surface 240) of the second lead-out portion 24 at the outermost end (X1 side in X1-X2 direction), which are located at the ends of the coil member 10, are exposed from the main body portion 30 on the side surfaces aligned in the X1-X2 direction in the main body portion 30. The first terminal member 41 (see FIG. 1) is provided so as to electrically contact the first lead-out exposed surface 140, and the second terminal member 42 (see FIG. 1) is provided so as to electrically contact the second lead-out exposed surface 240. The first terminal member 41 is an example of the first external electrode, and the second terminal member 42 is an example of the second external electrode. Outside the main body portion 30, the first terminal member 41 and the second terminal member 42 are electrically separated.

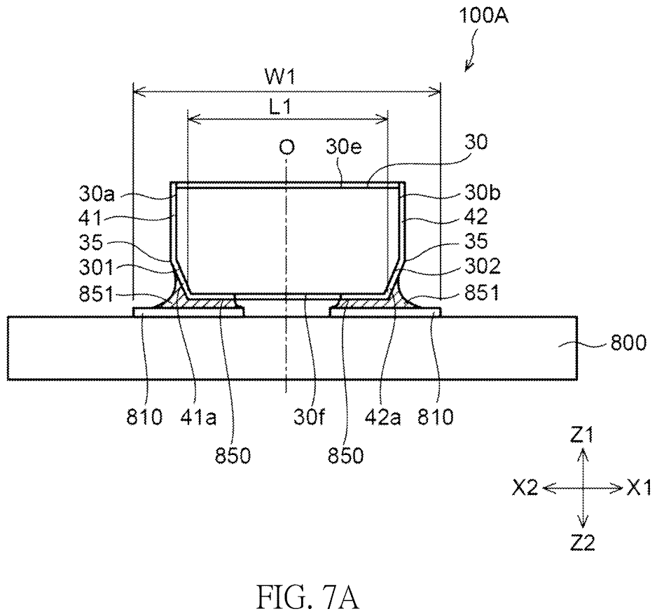

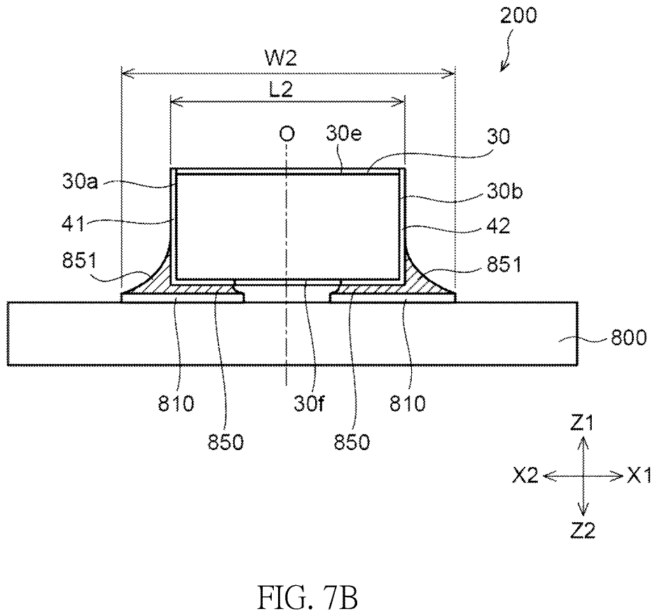

The first terminal member 41 has a bottom surface portion 41b (see FIG. 1) provided so as to cover a part of the second intersecting surface 30f of the main body portion 30. In addition, the second terminal member 42 has a bottom surface portion 42b (see FIG. 1) provided so as to cover another part of the second intersecting surface 30f of the main body portion 30. These bottom surface portions 41b and 42b become portions facing the substrate 800 when the coil component 100A is mounted on the substrate 800 (see FIG. 7A and FIG. 7B).

The materials and configurations of the first terminal member 41 and the second terminal member 42 are not limited as long as they have appropriate conductivity. Non-limiting examples of the first terminal member 41 and the second terminal member 42 include a layer having a structure of Cu plating/Ni plating/Sn plating from the side proximal to the surface of the main body portion 30. The first terminal member 41 and the second terminal member 42 may be composed of a coating-type electrode in which a conductive substance such as silver is dispersed in a resin or the like. The first terminal member 41 and the second terminal member 42 may be a combination of plating and a coating-type electrode.

### (Outer Cover)

An insulating outer cover 60 is provided, as an insulating layer, on the first intersecting surface 30e of the main body portion 30 and on the outer surfaces 30c and 30d aligned in the Y1-Y2 direction, respectively. In addition, an insulating outer cover 50 is provided on a portion of the second intersecting surface 30f of the main body portion 30 (between the bottom surface portion 41b and the bottom surface portion 42b) where the bottom surface portion 41b of the first terminal member 41 and the bottom surface portion 42b of the second terminal member 42 are not provided. The outer covers 50 and 60 may include a layer made of a resin having an average thickness of 0.10 μm to 15.0 μm. This makes it easy to maintain the magnetic properties of the coil component 100A, improve the insulation of the surface of the coil component 100A to enhance the reliability of the coil component 100A, and improve the appearance of the coil component 100A. The coil component 100A does not necessarily need to be provided with the outer covers 50 and 60. The outer covers 50 and 60 can be formed at arbitrary positions on the surface of the main body portion 30 depending on the purpose.

### (First Insulator Portion)

As shown in the cross-sectional views of FIG. 5 and FIG. 6, the coil insulator portion includes a first insulator portion 90 at least partially in contact with one of the end parts of the first spiral conductor portion 11 on one side in the first direction, specifically, the end part on the side facing the second spiral conductor portion 21 (Z2 side in Z1-Z2 direction). The first insulator portion 90 shown in the cross-sectional view of FIG. 5 at least partially contacts one of the end parts of the second spiral conductor portion 21 on one side in the first direction side, specifically, the end part on the side facing the first spiral conductor portion 11 (Z1 side in Z1-Z2 direction), which is the side opposite to the side contacting the first spiral conductor portion 11 (Z2 side in Z1-Z2 direction). That is, the first insulator portion 90 is interposed between the first spiral conductor portion 11 and the second spiral conductor portion 21 aligned in the first direction and contacts both. In this way, with the first insulator portion 90 contacting the first spiral conductor portion 11, the insulation of the first spiral conductor portion 11 is reliably performed. Also, by interposing the first insulator portion 90 between the first spiral conductor portion 11 and the second spiral conductor portion 21 and contacting both, a short circuit between the first spiral conductor portion 11 and the second spiral conductor portion 21 is stably avoided.

The material constituting the first insulator portion 90 is not limited as long as it has appropriate insulation properties. The first insulator portion 90 may preferably have a volume resistivity of 1.0×10¹⁴ Q·cm or more obtained by ASTM D257. The volume resistivity is more preferably 1.0×10¹⁵ Q·cm or more, and further preferably 1.0×10¹⁶ Q·cm or more. The upper limit of the volume resistivity is not particularly limited. The volume resistivity may be 1.0×10²⁰ Q·cm or less. In addition, the first insulator portion 90 is preferably excellent in dielectric properties, and specifically, it may be preferable that the relative permittivity at 60 Hz obtained by ASTM D150 is 4.0 or less. Preferably, the relative permittivity is 3.5 or less, and more preferably 3.0 or less. The lower limit of the relative permittivity is not particularly limited. The relative permittivity may be 1.0 or more. The method for measuring the volume resistivity and relative permittivity of the first insulator portion 90 is not limited. For example, there is a method of separately preparing a measurement sample prepared to a dimension necessary for measurement with a material corresponding to the first insulator portion 90, specifying a constituent material through an analysis method such as component analysis or FT-IR using the measurement sample, and evaluating properties such as volume resistivity for the material.

The material constituting the first insulator portion 90 may be composed of an organic material, an inorganic material, or a composite material of an organic material and an inorganic material. When the first insulator portion 90 is made of a composite material, the inorganic material may have a particle shape and be dispersed in a matrix composed of an organic material. Specific examples of organic materials include polyimide resins, polyethylene resins, polypropylene resins, polyamide resins, polyester resins, polyamide-imide resins, polysulfone resins, polycarbonate resins, liquid crystal polymer resins, polyvinylidene fluoride resins, and polytetrafluoroethylene resins. Specific examples of inorganic materials, particularly inorganic materials in composite materials, include inorganic materials such as oxides, carbides, nitrides, and inorganic salts. For example, oxides include silica, alumina, and zirconia. Further, for example, carbides and nitrides include silicon carbide, boron nitride, and silicon nitride, respectively. Inorganic salts include, for example, minerals such as wollastonite, kaolin, and mica. Among these, oxide-based materials such as oxides, silicates, and phosphates are preferable in terms of cost and insulation. For example, the inorganic material preferably contains at least one selected from the group consisting of silicon (Si), phosphorus (P), boron (B), and calcium (Ca).

### (Second Insulator Portion)

The coil insulator portion includes a second insulator portion 80, and as shown in FIG. 5 and FIG. 6, the second insulator portion 80 is provided at least patially on the surface of the first spiral conductor portion 11 and the surface of the second spiral conductor portion 21.

In the present embodiment, the material constituting the second insulator portion 80 is not limited as long as it has appropriate insulation properties. For example, the second insulator portion 80 is thermoplastic and contains a thermoplastic resin including a paraxylylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, and polytetrafluoroethylene. The second insulator portion 80 preferably has thermoplasticity as a whole, and may contain, for example, inorganic insulating particles in addition to the above thermoplastic resin. In addition, the second insulator portion 80 may be the same material as the first insulator portion 90.

The second insulator portion 80 is preferably excellent in insulation properties, and specifically, the volume resistivity obtained by ASTM D257 may preferably be 1.0×10¹⁴ Q·cm or more. The volume resistivity is more preferably 1.0×10¹³ Q·cm or more, and further preferably 1.0×10¹⁶ Q·cm or more. The upper limit of the volume resistivity is not particularly limited. The volume resistivity may be 1.0×10²⁰ Q·cm or less. In addition, the second insulator portion 80 is preferably excellent in dielectric properties, and specifically, it may be preferable that the relative permittivity at 60 Hz obtained by ASTM D150 is 4.0 or less. Preferably, the relative permittivity is 3.5 or less, and more preferably 3.0 or less. The lower limit of the relative permittivity is not particularly limited. The relative permittivity may be 1.0 or more. For measuring the volume resistivity and the relative permittivity, a separately prepared material corresponding to the second insulator portion 80 is prepared to a dimension necessary for measurement and used. The material corresponding to the second insulator portion 80 can be identified, for example, through an analysis method such as component analysis or FT-IR, as in the case of the first insulator portion 90.

### (Mounting State)

FIG. 7A and FIG. 7B are schematic diagrams illustrating a state in which the coil component is mounted on a substrate. FIG. 7A shows the mounting state of the coil component 100A according to the present embodiment, and FIG. 7B shows the mounting state of a coil component 200 according to a comparative example. The coil component 200 has an outer shape different from that of the coil component 100A. Specifically, the outer shape of the coil component 200 is substantially hexahedral, and does not have the tapered outer surfaces 301 and 302 that the outer surfaces 30a and 30b of the coil component 100A have. Therefore, when compared with the length of the intersection portion in the X1-X2 direction (length between terminal members) between the end on the X2 side in the X1-X2 direction of the portion located on the second intersecting surface 30f in the first terminal member 41 and the end on the X1 side in the X1-X2 direction of the portion located on the second intersecting surface 30f in the second terminal member 42, the length L2 between the terminal members in the coil component 200 is longer than the length L1 between the terminal members in the coil component 100A.

When mounting the coil components 100A and 200, the electrodes 810 provided on the substrate 800 and the first terminal member 41 and the second terminal member 42 are joined via solder 850 provided on the electrodes 810.

Here, in the fillet 851 formed during reflow, the melted solder 850 wets up along the outer surfaces 30a and 30b of the main body portion 30, thereby increasing the contact area between the solder 850 and the coil components 100A and 200, resulting in an improvement in conductivity and adhesion between the coil components 100A and 200 and the electrodes 810.

In order to appropriately secure the wetting up, it is preferable that the electrode 810 extends outside the coil components 100A and 200 and the solder 850 appropriately wets and spreads on the extending portion.

When the width of the coil component 100A according to the present embodiment shown in FIG. 7A is equal to the width of the coil component 200 according to the comparative example shown in FIG. 7B, the installation widths W1 and W2 of the electrodes 810 are considered taking into account the spread of the fillet 851 of the solder 850 in both cases. In the case of the coil component 200 according to the comparative example shown in FIG. 7B, since most of the spread of the fillet 851 is outside the outer surfaces 30a and 30b of the main body portion 30 of the coil component 200, the installation width W2 of the electrode 810 taking the spread of the fillet 851 into consideration is required.

On the other hand, in the coil component 100A according to the present embodiment shown in FIG. 7A, since the tapered outer surfaces 301, 302 are provided on the outer surfaces 30a, 30b of the main body portion 30, the area of the second intersecting surface 30f of the main body portion 30, which is on the mounting surface side of the coil component 100A, becomes smaller than the area of the first intersecting surface 30e, which is on the opposite side. Thereby, as described above, the length L1 between the terminal members of the coil component 100A is narrower than the length L2 between the terminal members of the coil component 200. Therefore, in the coil component 100A, without narrowing the width of the electrode 810 (length in X1-X2 direction), its installation width W1 can be made narrower than the installation width W2 of the electrode 810 required for mounting the coil component 200. When trying to increase the wetting-up height of the solder 850 on the tapered outer surfaces 301, 302, the fillet 851 inevitably spreads (increasing length in X1-X2 direction), so the width of the electrode 810 (length in X1-X2 direction) needs to be expanded. However, a wide installation width W1 of the electrode 810 becomes an obstacle from the viewpoint of realizing high-density mounting. Since the installation width W1 of the electrode 810 can be narrowed without narrowing the width of the electrode 810 (the length in the X1-X2 direction) as in the coil component 100A according to the present embodiment, the mounting density is improved without impairing the bonding quality of the coil component 100A.

Here, the tapered outer surfaces 301 and 302 may have a most distal portion 35 located most distal from the central axis O in the main body portion 30. By positioning the most distal portion 35 of the main body portion 30 on the tapered outer surfaces 301 and 302 in this manner, if the inclination angles of the tapered outer surfaces 301 and 302 with respect to the central axis O are the same, the mounting area of the coil component 100A after mounting can be made smaller than when the most distal portion 35 is located at the boundary with the first intersecting surface 30e, that is, when the most distal portion 35 is located at the Z1 side end of the main body portion 30 in the Z1-Z2 direction.

Moreover, in the coil component 100A, it is preferable that the surface roughness of the most distal portion 35 is made larger than the surface roughness of other portions on the tapered outer surfaces 301 and 302. Thus, by extending each of the first terminal member 41 and the second terminal member 42 so as to cover at least a portion of the most distal portion 35, the adhesion to the main body portion 30 of the first terminal member 41 and the second terminal member 42 covering at least a portion of the most distal portion 35 is improved.

The first terminal member 41 may have a side surface portion 41a provided so as to cover at least a part of the outer surface 30a including the tapered outer surface 301 of the main body portion 30. Also, the second terminal member 42 may have a side surface portion 42a provided so as to cover at least a part of the outer surface 30b including the tapered outer surface 302 of the main body portion 30. In this case, at least one of the first end surface of the first lead-out portion 14 (first lead-out exposed surface 140) and the second end surface of the second lead-out portion 24 (second lead-out exposed surface 240) may have a portion exposed from the tapered outer surfaces 301 and 302. Thereby, since the first terminal member 41 or the second terminal member 42 is positioned on the tapered outer surface 301 or 302, the conductivity of the first terminal member 41 and the second terminal member 42 is improved, and the adhesion with the solder 850 is improved. In the coil component 100A according to the present embodiment, as shown in FIG. 5 and FIG. 6, a portion of the second lead-out exposed surface 240, which is the second end surface (Z2 side in Z1-Z2 direction), is exposed from the tapered outer surface 302.

In the coil component 100A, the side surface portion 41a of the first terminal member 41 covers the tapered outer surface 301 of the outer surface 30a and further extends toward the first intersecting surface 30e, so the first terminal member 41 positioned on the outer surface 30a is multifaceted. Thereby, the adhesion of the first terminal member 41 of the coil component 100A to the main body portion 30 is improved in comparison with the coil component 200. Similarly, since the side surface portion 42a of the second terminal member 42 located on the outer surface 30b is also multifaceted, the adhesion of the second terminal member 42 to the main body portion 30 is improved.

In the coil component 100A, the tapered outer surfaces 301 and 302 may be relatively rich in processing marks of components in the first direction (Z1-Z2 direction). An example of processing causing such processing marks is push-cutting in which a blade moves in the first direction. The surface roughness of the tapered outer surfaces 301 and 302 having such processing marks becomes higher than that of a molded surface formed by an adjusting molding process using a mold, etc. which increases the overall pressure on the workpiece in the mold to transfer the surface shape of the mold to the workpiece. Therefore, the adhesion of members (specifically, the first terminal member 41 and the second terminal member 42 are exemplified) positioned so as to cover the tapered outer surfaces 301 and 302 to the main body portion 30 increases.

When processing is performed by push-cutting and the tapered outer surfaces 301 and 302 contain processing marks as described above, the magnetic powder located on the tapered outer surfaces 301 and 302 does not have a cut surface. In other words, the magnetic powder located on the tapered outer surfaces 301 and 302 is formed from unprocessed powder that has not been subjected to cutting. In the case that the magnetic powder is formed from unprocessed powder, corrosion is less likely to occur even if the magnetic powder contains a metallic material. Therefore, the main body portion 30 is excellent in stability of magnetic characteristics over time.

### Second Embodiment

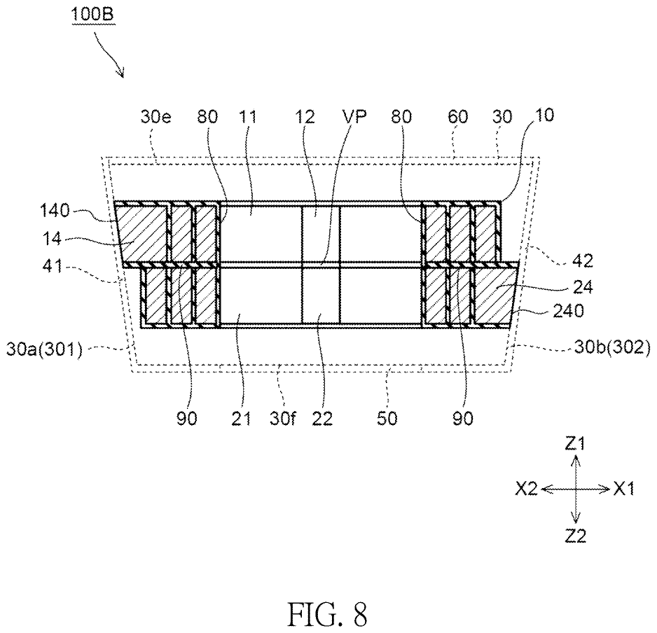

FIG. 8 is a cross-sectional view illustrating a coil component according to the second embodiment.

In the coil component 100B according to the second embodiment, the entire outer surface 30a of the main body portion 30 is the tapered outer surface 301, and the entire outer surface 30b of the main body portion 30 is the tapered outer surface 302. Thereby, when viewed from the first direction, the coil component 100B has a wider overlapping range with the electrode 810 in comparison with the coil component 100A according to the first embodiment. Therefore, when the coil component 100B is mounted, the amount of the fillet 851 (see FIG. 7A) of the solder 850 (see FIG. 7A) that falls into the shadow of the coil component 100B when viewed in the first direction can be increased, and it is realized to improve joining stability more than the coil component 100A without increasing the installation width W1 of the electrode 810 (see FIG. 7A).

### Third Embodiment

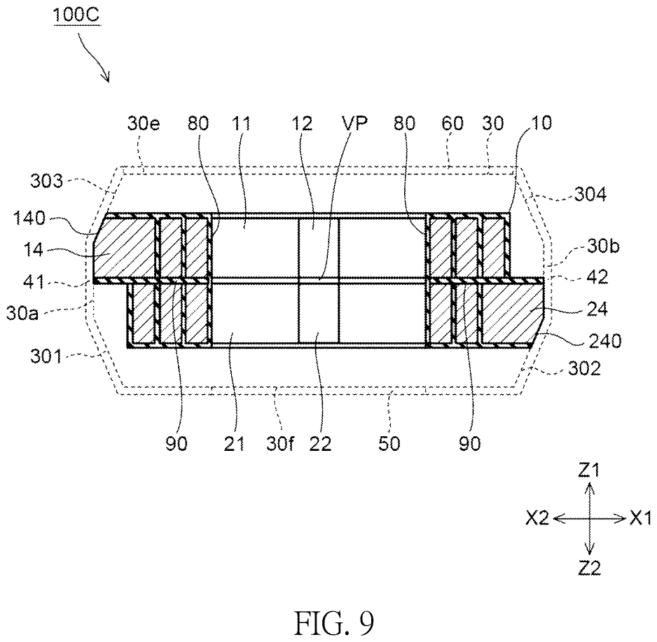

FIG. 9 is a cross-sectional view illustrating a coil component according to the third embodiment.

In the coil component 100C according to the third embodiment, the outer surface 30a of the main body portion 30 includes a tapered outer surface 301 and a tapered outer surface 303, and the outer surface 30b of the main body portion 30 includes a tapered outer surface 302 and a tapered outer surface 304. The tapered outer surface 303 is an inclined surface that approaches the central axis O (see FIG. 2) as it approaches the first intersecting surface 30e, opposite to the tapered outer surface 301. Moreover, the tapered outer surface 304 is an inclined surface that approaches the central axis O (see FIG. 2) as it approaches the first intersecting surface 30e, opposite to the tapered outer surface 302. A non-inclined surface may or may not be provided between the tapered outer surface 301 and the tapered outer surface 303 in the outer surface 30a.

### Fourth Embodiment

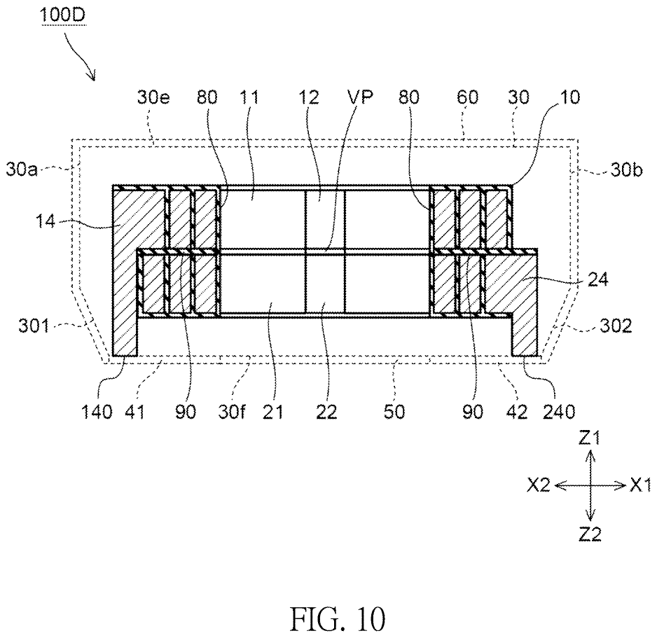

FIG. 10 is a cross-sectional view illustrating a coil component according to the fourth embodiment.

In the coil component 100D according to the fourth embodiment, at least a portion of the first lead-out exposed surface 140, which is the end surface of the first lead-out portion 14, is exposed from the second intersecting surface 30f, and at least a portion of the second lead-out exposed surface 240, which is the end surface of the second lead-out portion 24, is exposed from a portion on the second intersecting surface 30f different from the exposed portion of the first lead-out exposed surface 140. That is, in the coil component 100D, each of the first lead-out portion 14 and the second lead-out portion 24 extends to the Z2 side in the Z1-Z2 direction so as to reach the second intersecting surface 30f.

In this case, as shown in FIG. 10, the first lead-out exposed surface 140 and the second lead-out exposed surface 240 may not be exposed to the outer surfaces 30a and 30b of the main body portion 30, but may be exposed only to the second intersecting surface 30f of the main body portion 30. Alternatively, the first lead-out exposed surface 140 may be exposed from both the second intersecting surface 30f and the outer surface 30a, and the second lead-out exposed surface 240 may be exposed from both the second intersecting surface 30f and the outer surface 30b. That is, in the coil component 100D, at least a part of the first lead-out exposed surface 140 is configured to be exposed from the second intersecting surface 30f, and at least a part of the second lead-out exposed surface 240 is configured to be exposed from the second intersecting surface 30f.

In such a coil component 100D, conduction between the coil conductor portion 20 and the first terminal member 41 and the second terminal member 42 is performed at least on the second intersecting surface 30f of the main body portion 30. In this case, the first terminal member 41 and the second terminal member 42 may be provided only on a part of the second intersecting surface 30f of the main body portion 30.

### (Method for Manufacturing Coil Component)

Next, a method for manufacturing the coil component according to the present embodiment will be described. In the method for manufacturing the coil component according to the present embodiment, after performing a slit forming process and/or a groove forming process on a member including the coil member 10 and a semi-cured material 401h (details will be described later), a curing step of curing the semi-cured material 401h is performed. As a result, not only the above-mentioned coil components 100A to 100D according to the present embodiment but also the coil component 200 can be manufactured with high productivity.

### (First Manufacturing Method)

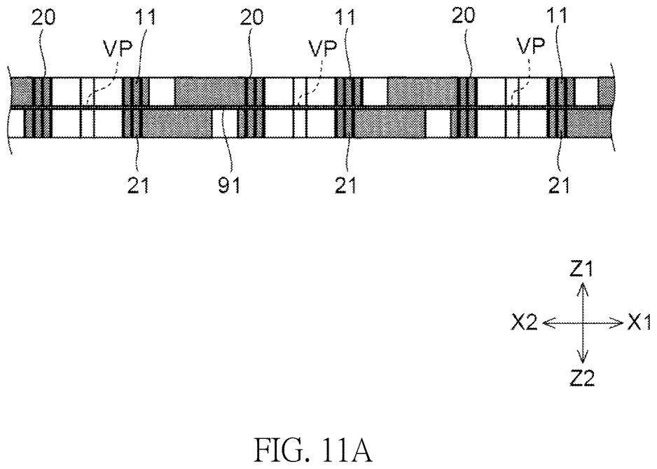

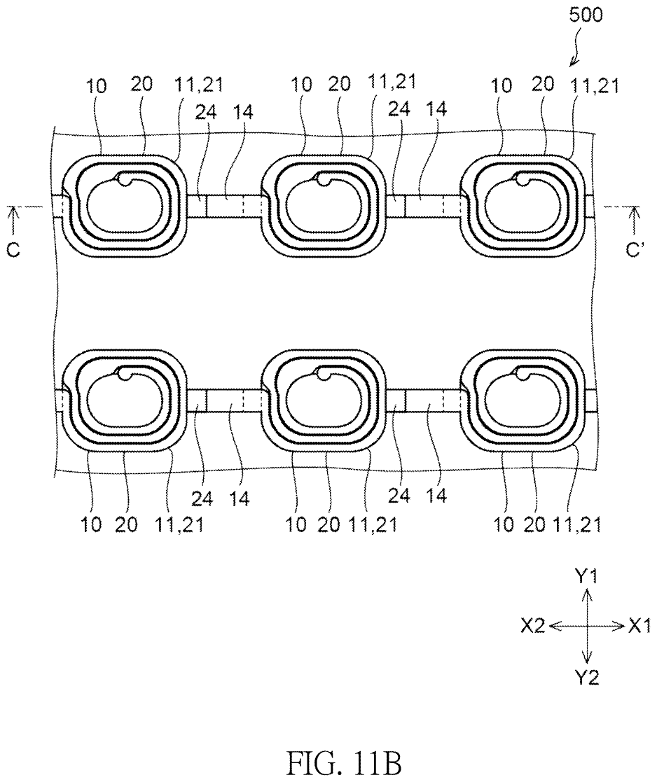

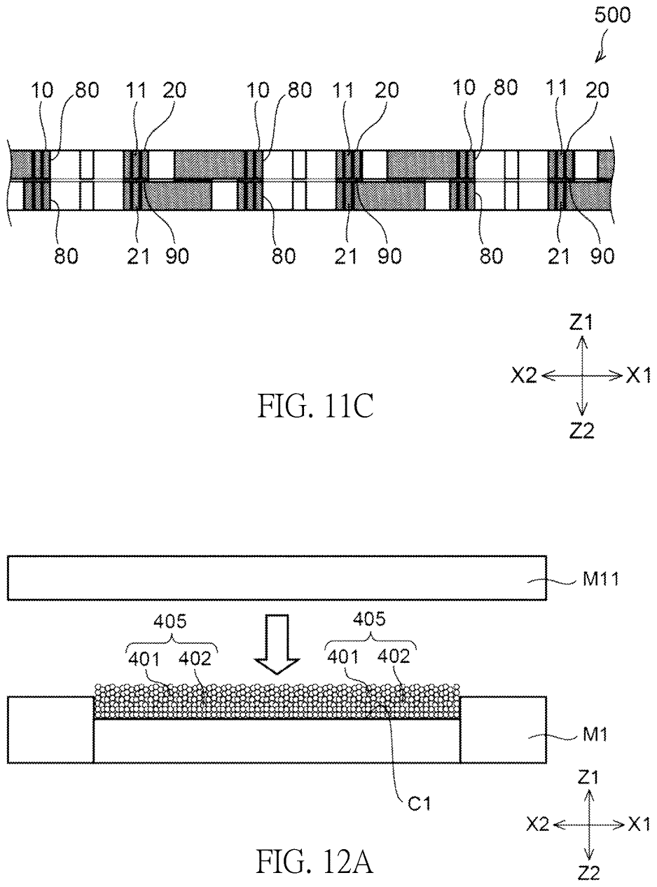

FIG. 11A to FIG. 19 are diagrams illustrating a first method for manufacturing a coil component.

First, as shown in FIG. 11A, a plurality of spiral portions (first spiral conductor portion 11, second spiral conductor portion 21) are formed. Specifically, the first spiral conductor portion 11 is formed on one surface (specifically, surface on Z1 side in Z1-Z2 direction) of an insulating sheet substrate 91, and the second spiral conductor portion 21 is formed on the other surface (specifically, surface on Z2 side in Z1-Z2 direction) of the sheet substrate 91. The process for forming the first spiral conductor portion 11 and the second spiral conductor portion 21 is not particularly limited. For example, they can be formed by a plating process. In the present embodiment, in this process, the via part VP and the first lead-out portion 14 and the second lead-out portion 24 are also formed simultaneously.

Here, the sheet substrate 91 is not particularly limited as long as it has mechanical properties for functioning as a support when forming the first spiral conductor portion 11 and the second spiral conductor portion 21, and suitability (removal characteristics) for the process described next. Specific examples of constituent materials for the sheet substrate 91 include organic materials, inorganic materials, and composite materials thereof. Specific examples of organic materials include thermoplastic resins such as polyimide resins and polyethylene resins, thermosetting resins such as epoxy resins and phenol resins, and cellulose. Specific examples of inorganic materials include oxide-based materials such as glass and alumina, metallic materials such as aluminum and magnesium, and inorganic salt-based materials such as calcium carbonate. As a specific example of the composite material, a structure in which an inorganic material is dispersed in a matrix of an organic material is exemplified. Among these materials, polyimide resin and epoxy resin are preferable. In particular, polyimide resin is most preferable in combination with a plating process.

Next, at least a portion of the sheet substrate 91 is removed. Specifically, when viewed in the first direction (Z1-Z2 direction), the sheet substrate 91 is removed, including a region of the sheet substrate 91 surrounded by the inner edge of the first spiral conductor portion 11. In the sheet substrate 91, portions at both ends in the first direction on which components of the coil conductor portion 20 (first spiral conductor portion 11, second spiral conductor portion 21, etc.) are remained without being removed, and form the first insulator portion 90 (see FIG. 11C).

A specific removal process for the sheet substrate 91 is appropriately set according to the material constituting the sheet substrate 91. The removal process is roughly classified into dry processes such as plasma etching and wet processes such as wet etching. Depending on the removal process, a portion of the sheet substrate 91 may be removed and the remaining portion may remain. For example, when the sheet substrate 91 is made of a composite material of an organic material and an inorganic material, only the organic material may be removed in the removal process.

Next, insulating coating is applied to the exposed surfaces of the coil conductor portions 20 such as the first spiral conductor portion 11 and the second spiral conductor portion 21. The process for forming the insulating coating is appropriately set according to the material constituting the second insulator portion 80. For example, when the second insulator portion 80 is composed of a paraxylylene-based polymer, it is formed by a dry process (CVD). When the second insulator portion 80 contains a curable resin material such as an epoxy resin, it can be formed by attaching a powdery or liquid material containing the constituent material of the second insulator portion 80 to the exposed surface, and then solidifying the attached material by heating or the like. Other examples include dip coating, sputtering, PVD, and an auto-deposition method. Thus, as shown in the XY plan view of FIG. 11B and the XZ cross-sectional view of FIG. 11C (cross section taken along line C-C′ in FIG. 11B), a coil array sheet 500 is formed in which a plurality of coil members 10 are supported by the first insulator portion 90 consisting of the remaining portion of the sheet substrate 91.

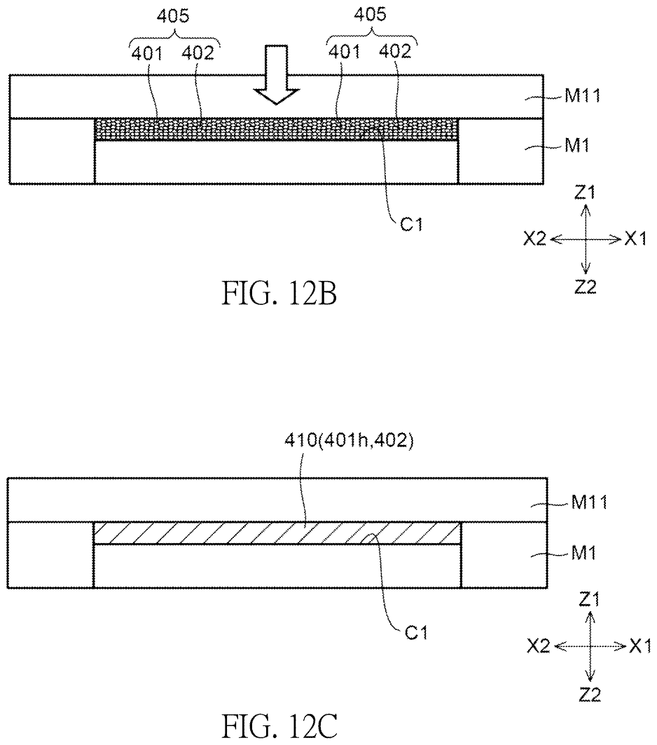

Next, as shown in FIG. 12A to FIG. 12C, a first member 410 containing a semi-cured material 401h of a curable material 401 and a magnetic powder 402 is formed. Specifically, as shown in FIG. 12A, a member material 405 containing a curable material 401 and a magnetic powder 402 is accommodated in a cavity C1 of a mold M1, and as shown in FIG. 12B, the member material 405 inside the cavity C1 is heated while being pressed by an upper mold M11. By the pressing and heating, the curing of the curable material 401 proceeds to some extent, and the semi-cured material 401h having plasticity in a state before the degree of curing reaches that of the binder 403 is formed. Thus, as shown in FIG. 12C, the first member 410 containing the semi-cured material 401h and the magnetic powder 402 is formed in the cavity C1 of the mold M1. Since the first member 410 contains the semi-cured material 401h having plasticity, it is in a so-called B-stage state having plasticity as a whole. The curable material 401 contained in the member material 405 may already be the semi-cured material 401h at a stage before being placed in the cavity C1 of the mold M1. In this case, only pressing is applied to the member material 405 inside the mold M1, whereby the semi-cured material 401h is plastically deformed, forming the first member 410 having a shape corresponding to the cavity C1.

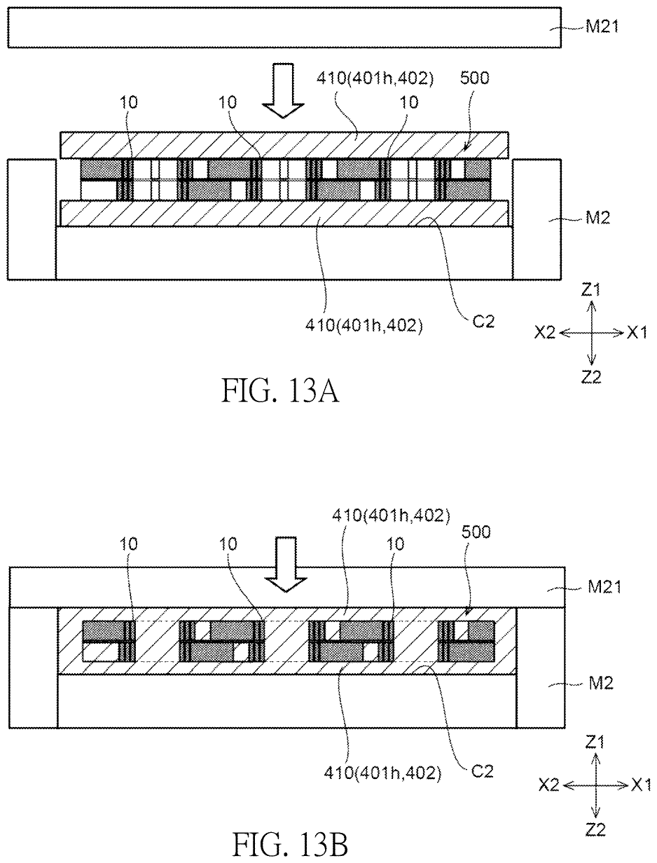

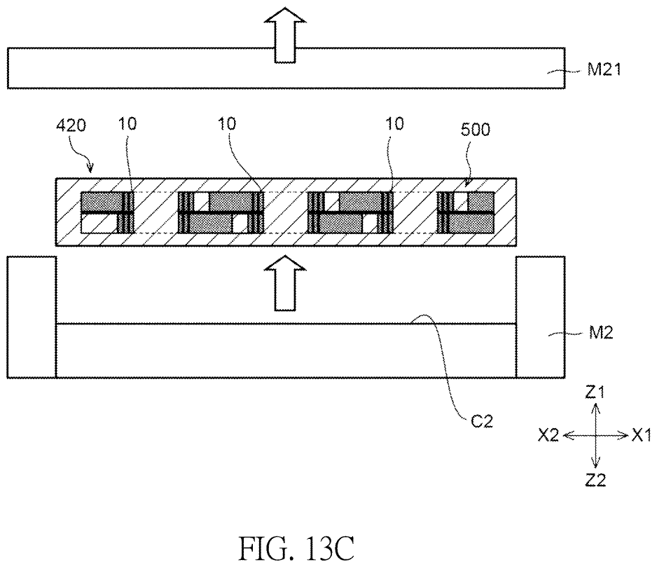

Next, as shown in FIG. 13A and FIG. 13B, the first member 410 and the coil members 10 are housed in a cavity C2 of a mold M2. Specifically, a plurality of coil members 10 are included in the coil array sheet 500. The coil array sheet 500 including the coil members 10 is sandwiched between a pair of first members 410 within the cavity C2, and in this state, is pressed by an upper mold M21. By being pressed by the upper mold M21, the pair of first members 410 are integrated inside the cavity C2, and a first intermediate member 420 (see FIG. 13C) in which the coil members 10 are embedded in the integrated first member 410 is formed.

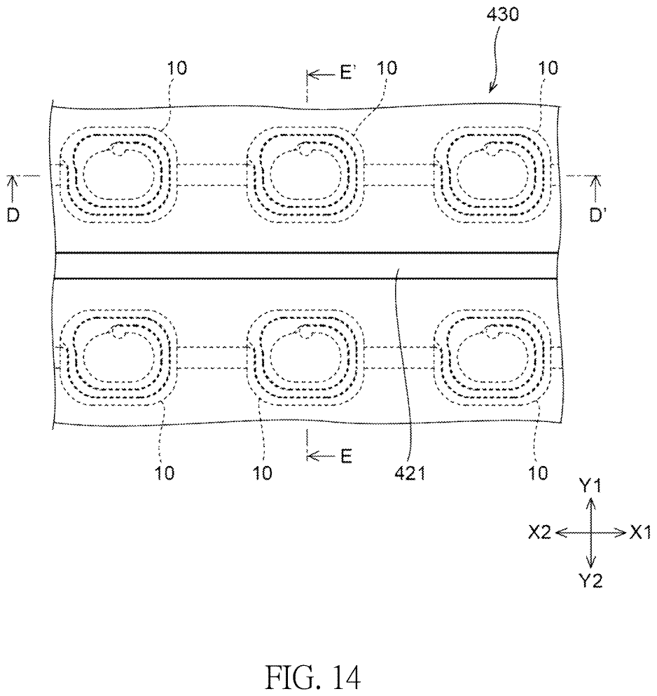

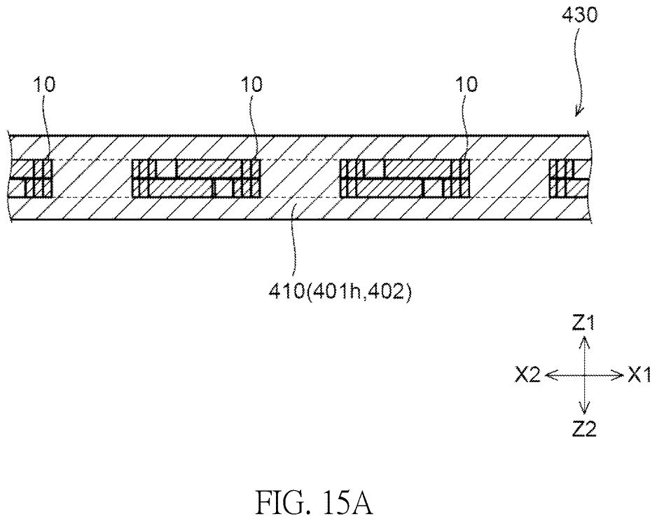

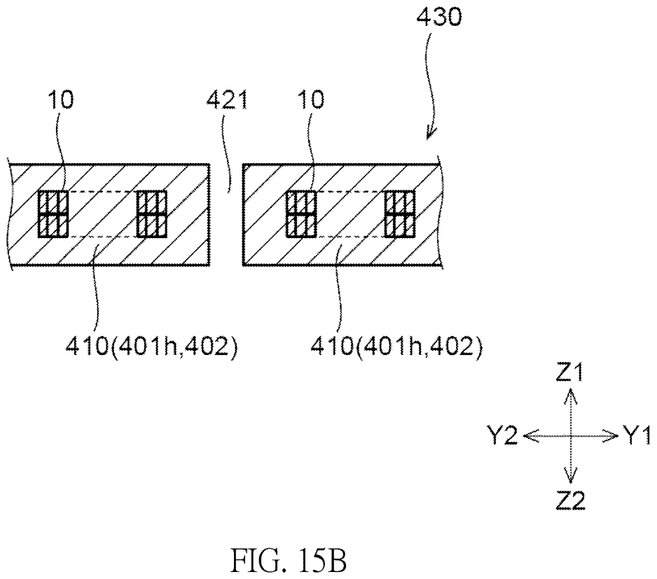

Next, as shown in FIG. 14 to FIG. 15B, a slit forming process is performed on the first intermediate member 420 containing the semi-cured material 401h (see FIG. 13C) to obtain a second intermediate member 430. FIG. 14 shows an XY plan view of the second intermediate member 430, FIG. 15A shows a cross section taken along line D-D′ in FIG. 14, and FIG. 15B shows a cross section taken along line E-E′ in FIG. 14.

In the slit forming process performed in the manufacturing method, a slit 421 penetrating the first intermediate member 420 in the Z1-Z2 direction along the X1-X2 direction is formed between the plurality of coil members 10 aligned in the Y1-Y2 direction. Thereby, the second intermediate member 430 formed by dividing the first intermediate member 420 into a plurality of parts is formed. The specific processing means for the slit forming process is arbitrary, and specific examples thereof include push-cutting with a blade and cutting with a dicing saw. FIG. 14 to FIG. 15B show a case where cutting with a dicing saw is performed.

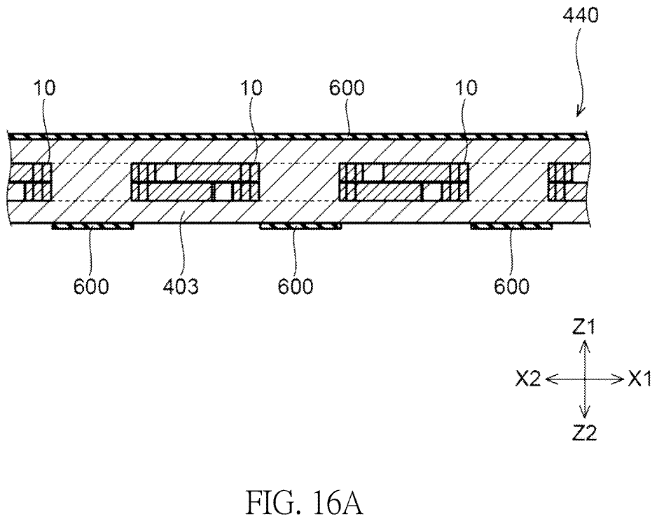

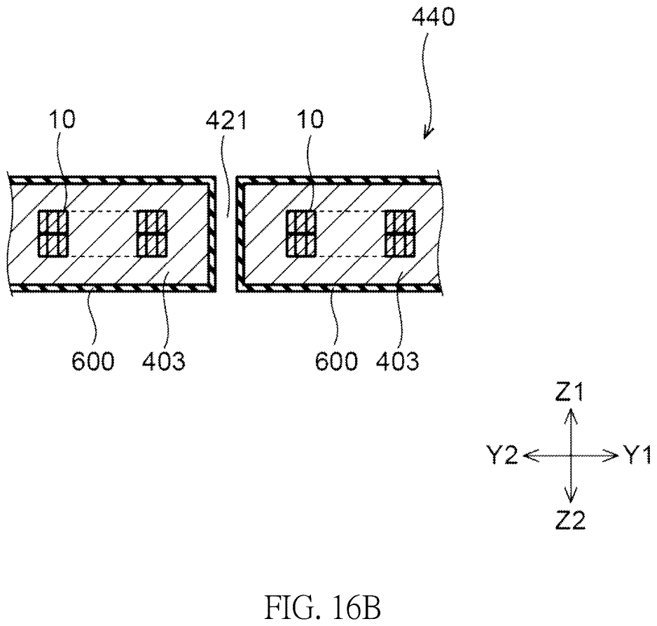

After forming the second intermediate member 430, a curing process is performed to cure the semi-cured material 401h included in the second intermediate member 430 into a binder 403 (see FIG. 16A). Thereby, a third intermediate member 440 (see FIG. 16A) is formed. The specific conditions for the curing process are appropriately set according to the composition and curing state of the semi-cured material 401h, and a specific example is maintaining at about 175° C. for 5 hours.

Next, as shown in FIG. 16A and FIG. 16B, outer cover processing is applied to the third intermediate member 440. FIG. 16A shows a cross section of the third intermediate member 440 viewed at the same position as the line D-D′ in FIG. 14, and FIG. 16B shows a cross section of the third intermediate member 440 viewed at the same position as the line E-E′ in FIG. 14. By the outer cover processing, necessary portions of the surface of the third intermediate member 440, including the inner side surface of the slit 421 formed by the slit forming process, are covered with an outer cover material 600.

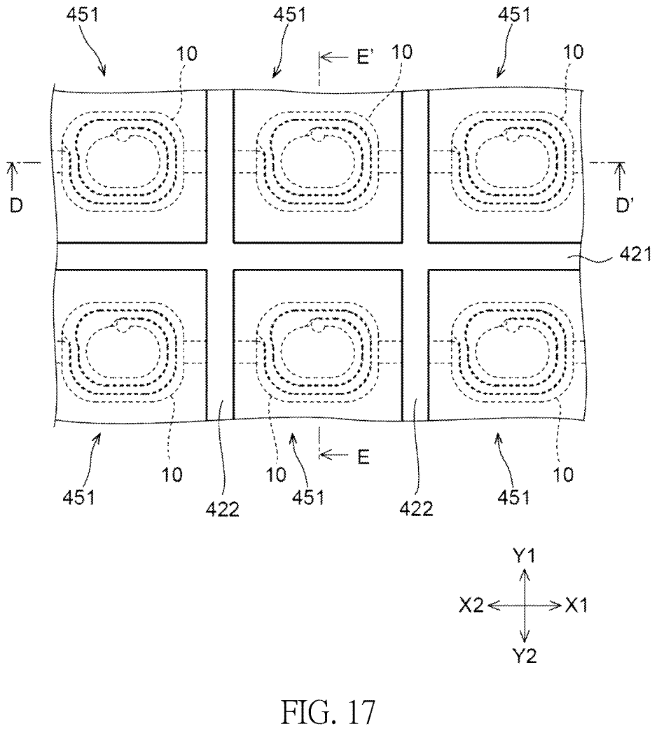

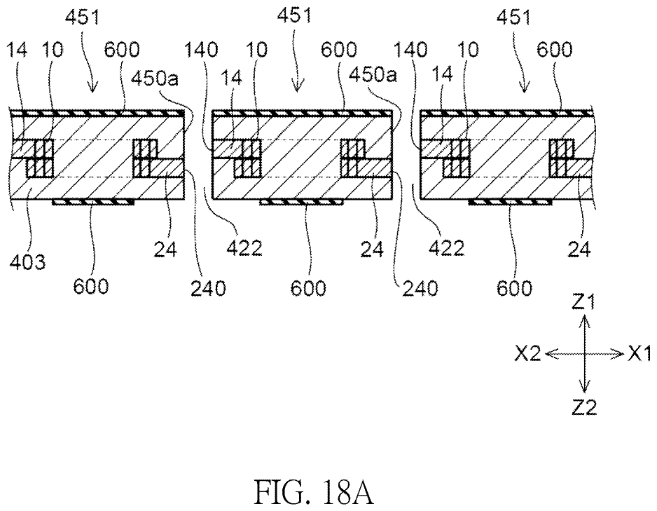

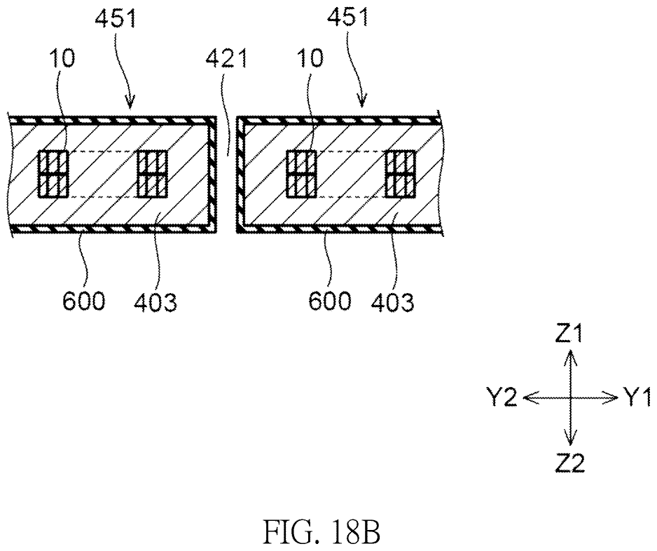

Next, as shown in FIG. 17 to FIG. 18B, the third intermediate member 440 (see FIG. 16A) is divided into individual pieces. FIG. 17 shows an XY plan view after the third intermediate member 440 shown in FIG. 16A is separated into pieces, FIG. 18A shows a cross section taken along line D-D′ in FIG. 17, and FIG. 18B shows a cross section taken along line E-E′ in FIG. 17.

In the manufacturing method, a dividing process is performed in a direction orthogonal to the processing direction of the slit forming process (specifically, Y1-Y2 direction) to divide the third intermediate member 440 into the plurality of coil members 10 aligned in the X1-X2 direction. By the dividing process, slits 422 penetrating the third intermediate member 440 in the Z1-Z2 direction along the Y1-Y2 direction are formed between the plurality of coil members 10 aligned in the X1-X2 direction. Processing means for the dividing process is arbitrary, and specific examples include push-cutting with a blade and cutting with a dicing saw. FIG. 18A shows a case that performs cutting with a dicing saw. By dividing the third intermediate member 440, the third intermediate member 440 is separated into pieces with individual coil members 10 to form coil component materials 451. In the coil component material 451, when the third intermediate member 440 is divided by cutting with a dicing saw, the first lead-out portion 14 and the second lead-out portion 24 of the coil member 10 are formed, and the first lead-out exposed surface 140 and the second lead-out exposed surface 240 are exposed from the inner side surface (first processed surface 450a) of the slit 422 formed by the dividing process.

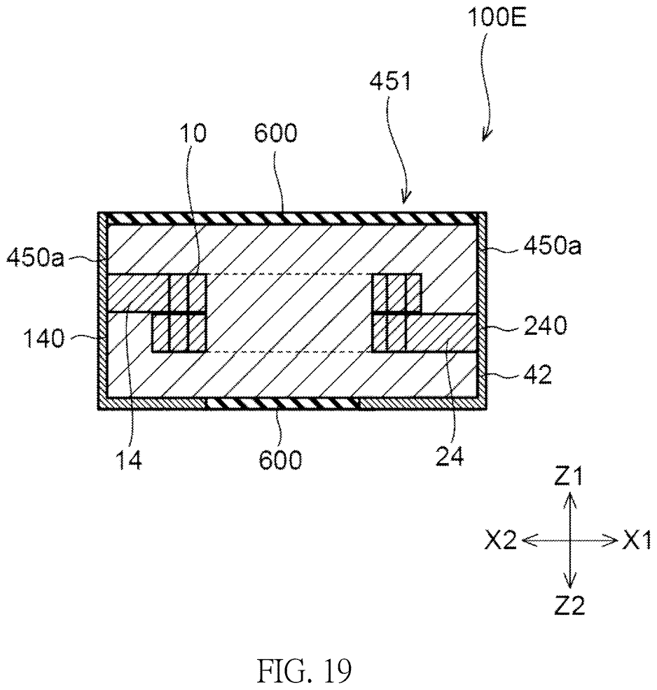

After forming the coil component materials 451, as shown in FIG. 19, the first terminal member 41 and the second terminal member 42 are formed on the surface of the coil component material 451 where the outer cover material 600 is not provided, including the first processed surface 450a. Since the first lead-out exposed surface 140 and the second lead-out exposed surface 240 are exposed from the first processed surface 450a of the coil component material 451, by forming the first terminal member 41 and the second terminal member 42 on the first processed surface 450a, conduction between the coil member 10 and the first terminal member 41 and the second terminal member 42 is achieved here. Thus, a coil component 100E is completed. Note that the shape of the coil component 100E is identical to the shape of the coil component 200. Therefore, according to the first manufacturing method relating to the present embodiment, it is possible to manufacture the coil component 200 according to the prior art with high productivity.

### (Second Manufacturing Method)

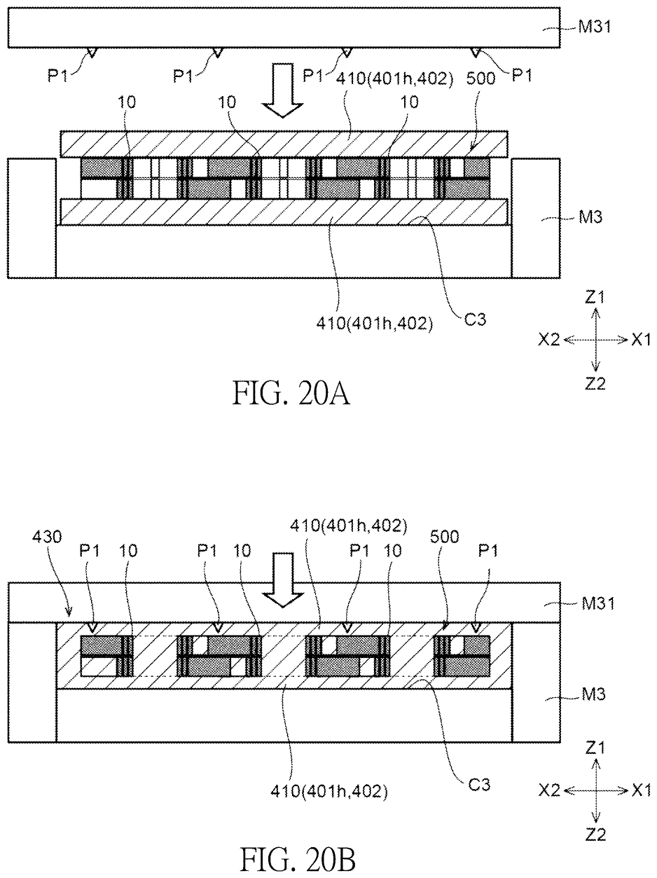

FIG. 20A to FIG. 26B are diagrams illustrating a second method for manufacturing a coil component.

In the second manufacturing method, the process up to the formation of the coil array sheet 500 and the first member 410 is the same as the first manufacturing method. Next, as shown in FIG. 20A, the first member 410 and the coil members 10 are housed in a cavity C3 of a mold M3. In the manufacturing method, a plurality of coil members 10 are included in the coil array sheet 500. The coil array sheet 500 including the coil members 10 is sandwiched between a pair of first members 410 within the cavity C3, and in this state, is pressed by an upper mold M31.

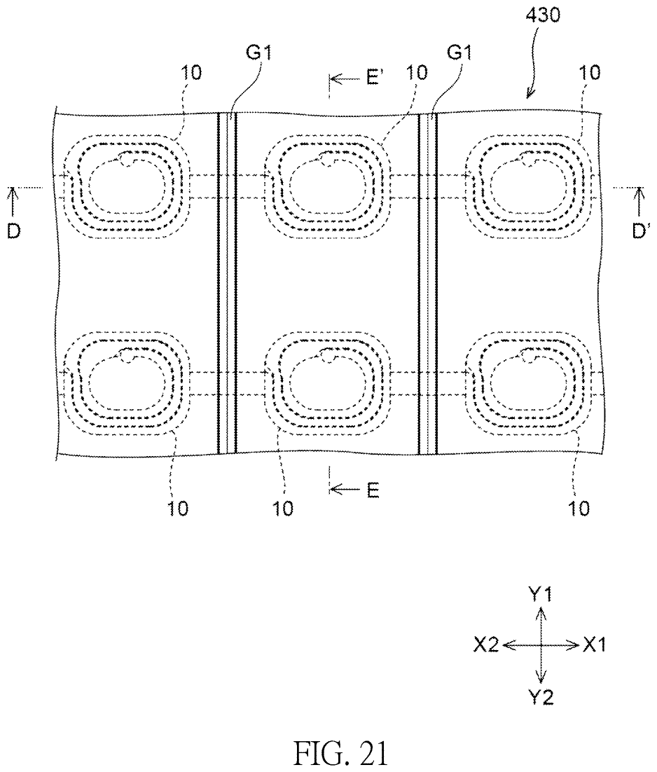

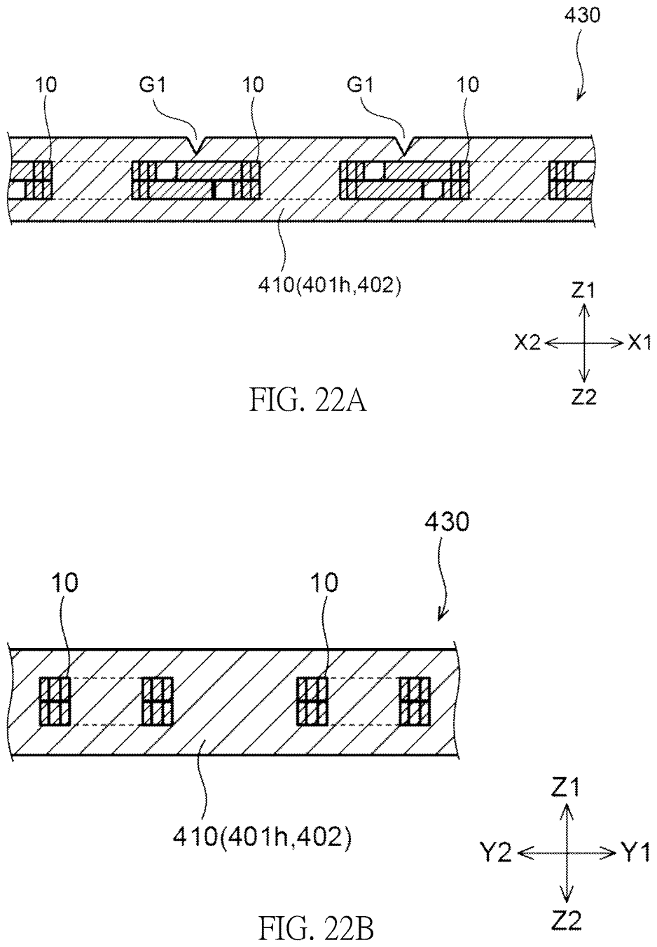

In the second manufacturing method, the upper mold M31 is provided with mountain-shaped protrusions P1. By pressing these protrusions P1 toward the first member 410 side with the upper mold M31, the pair of first members 410 are integrated across the coil member 10 within the cavity C3. At this time, a groove forming process is performed by processing a portion of the first member 410 with the protrusions P1 to form grooves G1, thereby forming a second intermediate member 430. That is, as shown in FIG. 20B, in the second manufacturing method, unlike the first manufacturing method, the processing for forming the first intermediate member 420 and the groove forming process for forming the grooves G1 are performed in a single step to form the second intermediate member 430. Therefore, the member taken out from the mold M3 becomes the second intermediate member 430 (see FIG. 21 to FIG. 22B).

The shape, size, and arrangement of the protrusions P1 (see FIG. 20A and FIG. 20B) which are the processing means for the groove forming process in this example are appropriately set. As will be described later, when performing a breaking process from the surface of the groove G1 formed by the protrusion P1, the shape of the protrusion P1 is set so that the surface of the groove G1 has a shape where the starting point of the breaking process is easily formed.

FIG. 21 to FIG. 22B show the second intermediate member 430 having the grooves G1. FIG. 21 shows an XY plan view of the second intermediate member 430, FIG. 22A shows a cross section taken along line D-D′ in FIG. 21, and FIG. 22B shows a cross section taken along line E-E′ in FIG. 21.

The second intermediate member 430 has a substantially V-shaped groove G1 to which the shape of the protrusion P1 (see FIG. 20A and FIG. 20B) is transferred. The protrusions P1 are arranged at positions corresponding to between the plurality of coil members 10, and are provided extending in one direction (specifically, Y1-Y2 direction). Thereby, the grooves G1 are also provided extending in one direction (specifically, Y1-Y2 direction) between the plurality of coil members 10 in accordance with the extension of the protrusions P1. Specifically, the groove G1 is provided on the Z1 side in the Z1-Z2 direction of the second intermediate member 430, and is provided in a substantially V-shape pointing toward the Z2 side.

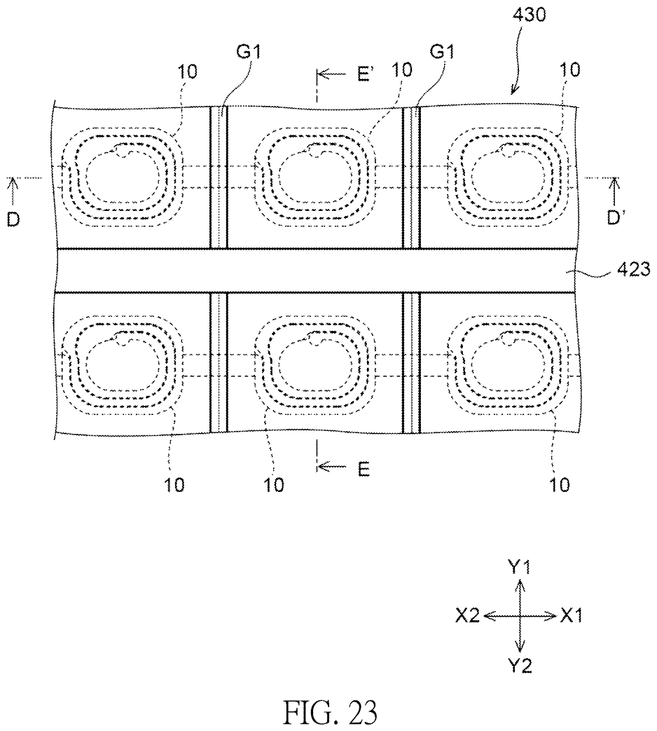

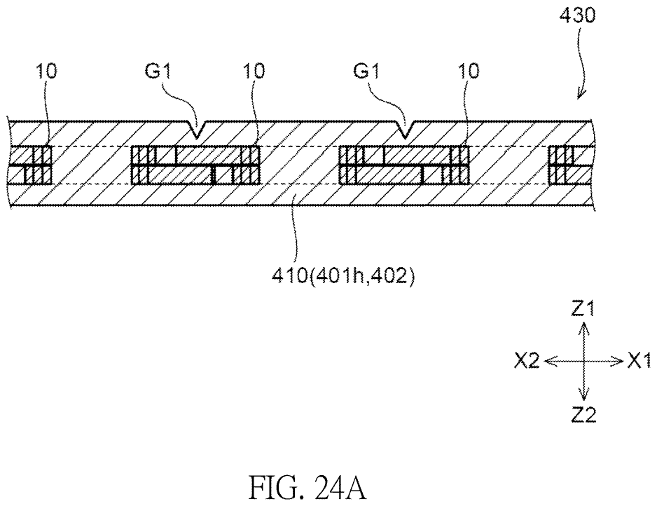

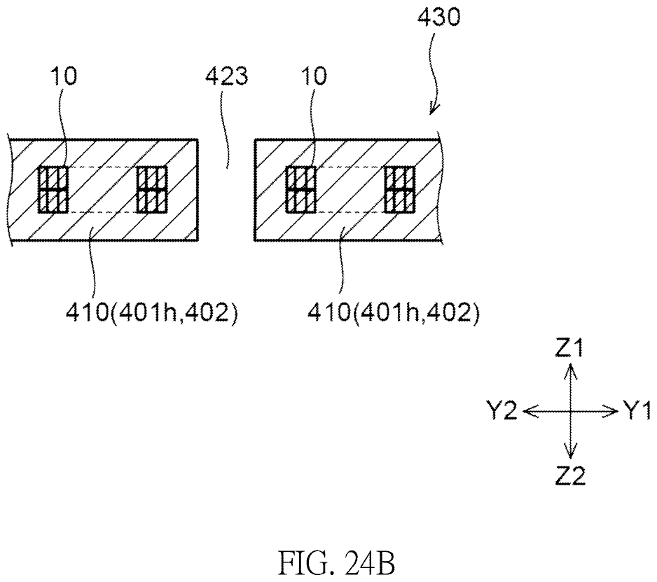

Next, as shown in FIG. 23 to FIG. 24B, a slit forming process is performed on the second intermediate member 430. FIG. 23 shows an XY plan view of the second intermediate member 430, FIG. 24A shows a cross section taken along line D-D′ of FIG. 23, and FIG. 24B shows a cross section taken along line E-E′ of FIG. 23.

By the slit forming process, slits 423 are formed between the plurality of coil members 10 aligned in the Y1-Y2 direction, penetrating the second intermediate member 430 in the Z1-Z2 direction along the X1-X2 direction, and the second intermediate member 430 is divided into a plurality of pieces. The processing means for the slit forming process is arbitrary, and specific examples include push-cutting with a blade and cutting with a dicing saw. FIG. 23 and FIG. 24B show a case that performs cutting with a dicing saw as the slit forming process. The surface formed by the slit forming process (inner side surface of slit 423) is along the first direction (Z1-Z2 direction). By processing in this way, compared to the case where the inner side surface of the slit 423 includes a tapered surface, it is possible to increase the volume of the main body portion 30 and enhance the magnetic characteristics.

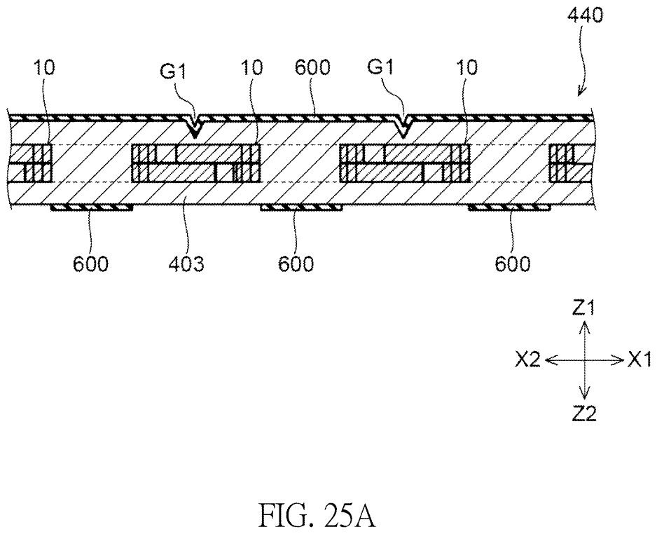

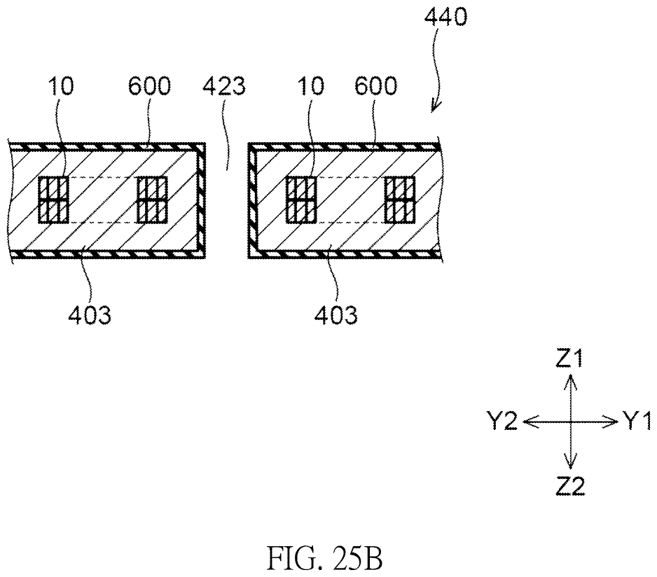

After forming the slits 423 in the second intermediate member 430, a curing process is performed to cure the semi-cured material 401h contained in the second intermediate member 430 into a binder 403 (see FIG. 25A). Thereby, a third intermediate member 440 (see FIG. 25A) is formed. The specific conditions of the curing process are appropriately set depending on the composition and curing state of the semi-cured material 401h, and a specific example is maintaining at about 175° C. for 5 hours.

Next, as shown in FIG. 25A and FIG. 25B, an outer cover processing is applied to the third intermediate member 440. FIG. 25A shows a cross section of the third intermediate member 440 viewed at the same position as the line D-D′ in FIG. 23, and FIG. 25B shows a cross section of the third intermediate member 440 viewed at the same position as the line E-E′ in FIG. 23. By the outer cover processing, necessary portions of the surface of the third intermediate member 440 including the inner side surface of the slit 423 formed by the slit forming process are covered with the outer cover material 600.

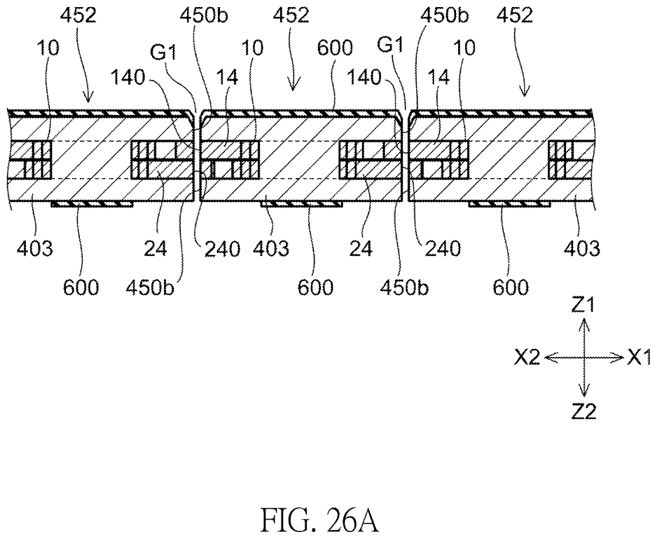

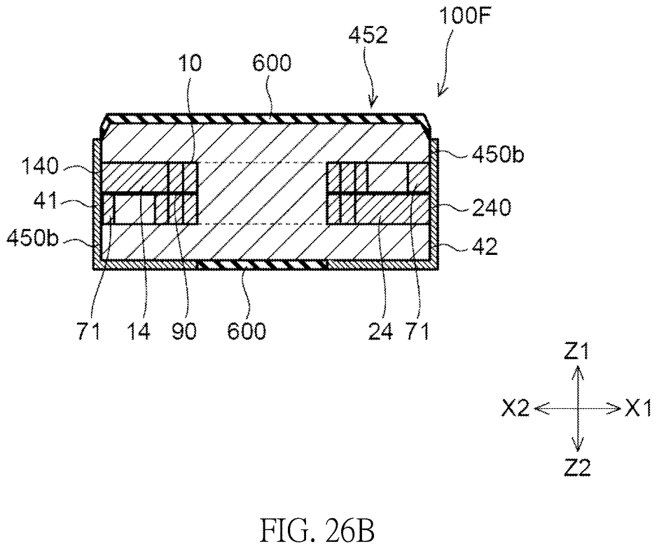

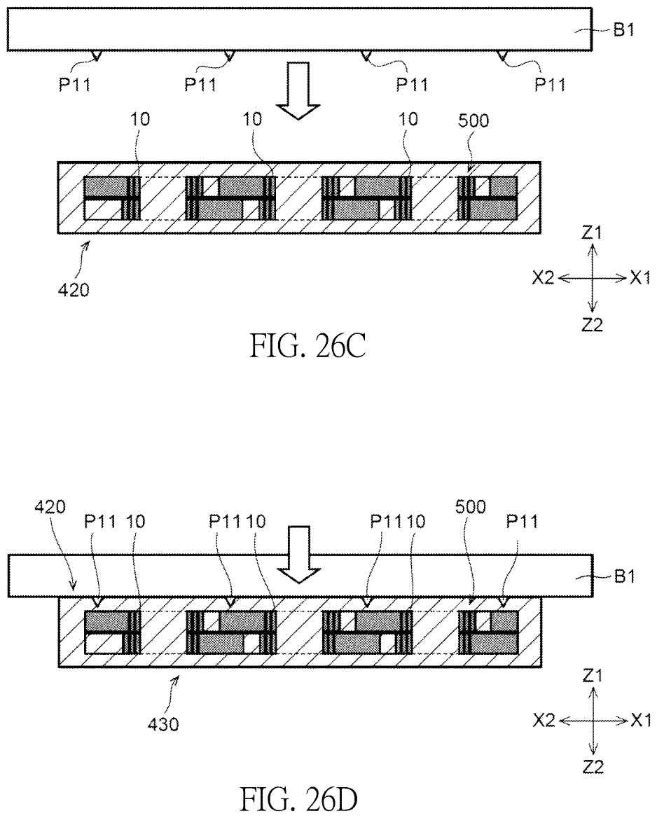

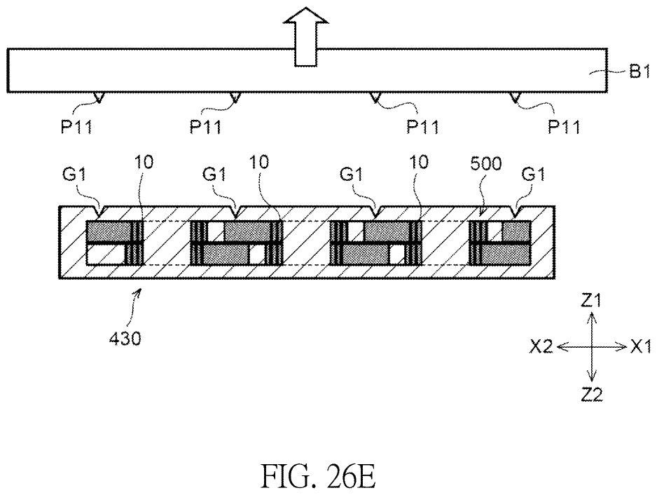

Next, the third intermediate member 440 having a plurality of coil members 10 arranged in the X1-X2 direction is subjected to a breaking process to be broken from the surface having the grooves G1 formed in the groove forming process (see FIG. 26A to FIG. 26B). As a result, the third intermediate member 440 is divided, and a second processed surface 450b including the extension direction of the groove G1 (Y1-Y2 direction) and the first direction (Z1-Z2 direction) as in-plane directions is formed on the third intermediate member 440.

In the manufacturing method, the breaking process is performed by an existing snap-break method. By the breaking process, the third intermediate member 440 including the plurality of coil members 10 aligned in the X1-X2 direction is separated into pieces with individual coil members 10 to form coil component materials 452. In the coil component material 452, the first lead-out portion 14 and the second lead-out portion 24 of the coil member 10 are formed upon the breaking process of the third intermediate member 440, and the first lead-out exposed surface 140 and the second lead-out exposed surface 240 are exposed from the second processed surface 450b.

After forming the coil component materials 452, as shown in FIG. 26B, the first terminal member 41 and the second terminal member 42 are formed on the surface of the coil component material 452 where the outer cover material 600 is not provided, including the second processed surface 450b. Since the first lead-out exposed surface 140 and the second lead-out exposed surface 240 are exposed from the second processed surface 450b of the coil component material 452, by forming the first terminal member 41 and the second terminal member 42 on the second processed surface 450b, conduction between the coil member 10 and the first terminal member 41 and the second terminal member 42 is achieved here. Thus, a coil component 100F is completed.

In the coil component 100F (see FIG. 26B) obtained by the second manufacturing method, dummy electrodes 71 are formed at positions opposite to the first lead-out portion 14 and at positions opposite to the second lead-out portion 24 with the first insulator portion 90 interposed therebetween. The dummy electrodes 71 are not electrically connected to the first terminal member 41 and the second terminal member 42, and are not electrically connected to the first spiral conductor portion 11 and the second spiral conductor portion 21 either. When forming the coil array sheet 500, it is possible to manufacture the coil component 100F in which the dummy electrodes 71 are substantially not formed by shortening the length in the X1-X2 direction of the overlapping portion in the first direction (Z1-Z2 direction) between the portion extending outside the first lead-out portion 14 and the portion extending outside the second lead-out portion 24. Alternatively, by performing the slit forming process instead of the breaking process to obtain the coil component material 452, the coil component 100F in which the dummy electrodes 71 are substantially not formed can be manufactured.

### (First Modification Example of Second Manufacturing Method)

In the second manufacturing method described above, the curing process to obtain the binder 403 by curing the semi-cured material 401h may be performed between the groove forming process for forming the grooves G1 shown in FIG. 21 to FIG. 22B and the slit forming process for forming the slits 423 shown in FIG. 23. In this case, the slit forming process for forming the slit 423 shown in FIG. 23 is performed on the third intermediate member 440 including the binder 403 formed by curing the semi-cured material 401h. Therefore, in the groove forming process for forming the grooves G1, the semi-cured material 401h easily undergoes plastic deformation during processing. As a result, the magnetic powder 402 moves relatively easily inside the first intermediate member 420. Therefore, a cut surface of the magnetic powder 402 is unlikely to be formed. On the other hand, the third intermediate member 440 in a state that the magnetic powder 402 is supported by the binder 403 formed by curing the semi-cured material 401h is cut in the slit forming process for forming the slit 423. As such, the magnetic powder 402 is relatively difficult to move inside the third intermediate member 440. Therefore, a cut surface of the magnetic powder 402 is easily formed.

### (Second Modification Example of Second Manufacturing Method)

In the above second manufacturing method, formation of the first intermediate member 420 and the second intermediate member 430 are performed in a single step, which includes the process of forming the first intermediate member 420 and the groove forming process of forming the grooves G1, with the mold M3 shown in FIG. 21 to FIG. 22B and the upper mold M31 having the protrusion P1. However, these processes may also be performed in separate steps.

Specifically, after the first intermediate member 420 is formed using a mold without a protrusion P1, as shown in FIG. 26C to FIG. 26E, the grooves G1 may be formed by push-cutting using a blade tool B1 having a protruding blade P11 on the first intermediate member 420 taken out of the mold. In this case, the semi-cured material 401h is easily plastically deformed during the processing. Therefore, the magnetic powder 402 moves relatively easily inside the first intermediate member 420, and the cut surface of the magnetic powder 402 is unlikely to be formed. Therefore, even when the magnetic powder 402 has a portion made of a metallic material, corrosion is unlikely to occur.

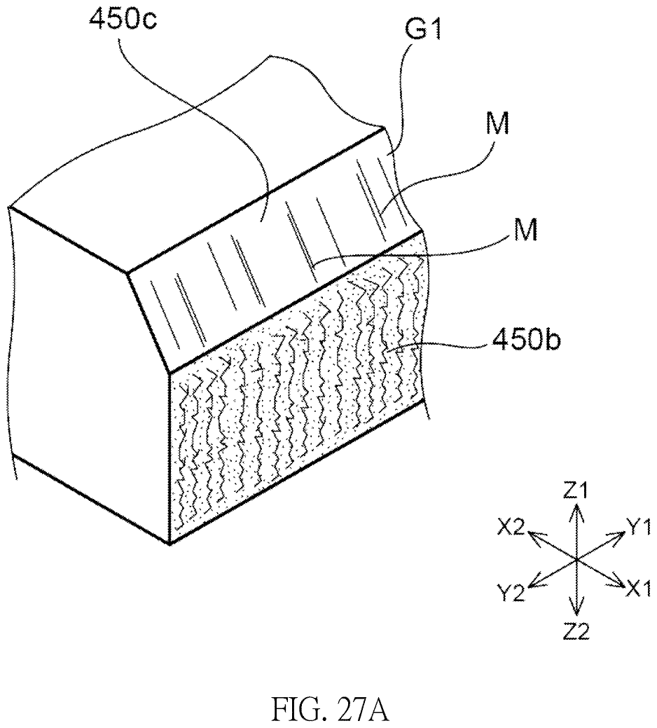

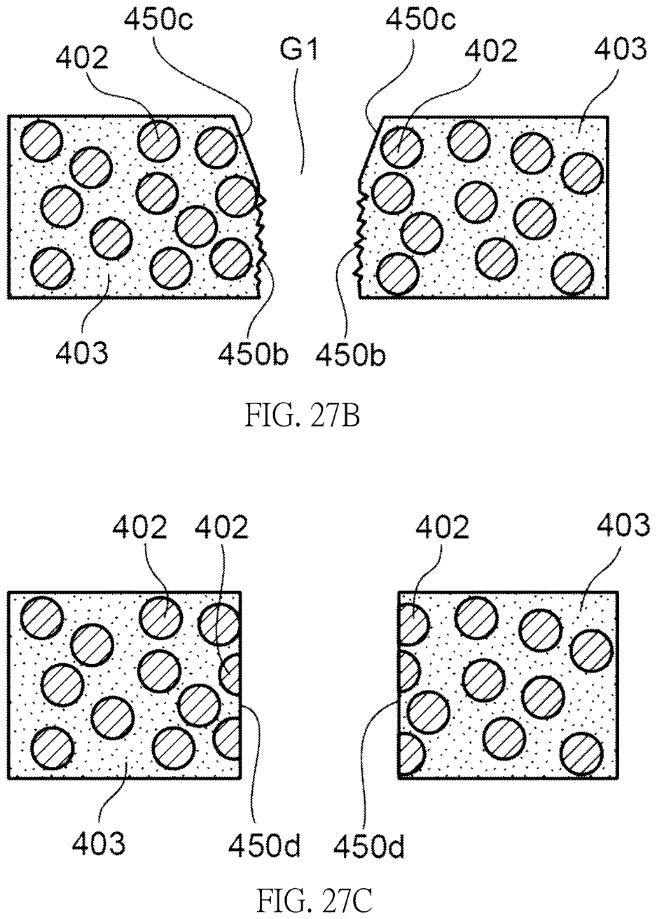

FIG. 27A is a schematic perspective view illustrating a state of a surface formed by a groove forming process and a surface formed by a breaking process. FIG. 27A shows the state of the outer surface 30b (see FIG. 2) of the main body portion 30 (see FIG. 2) formed by the breaking process starting from a portion (grooves G1) formed by the groove forming process.

The side surface of the groove G1 formed by the groove forming process has a third processed surface 450c relatively rich in processing marks M having a component in the first direction (Z1-Z2 direction) formed by push-cutting by the protrusions P1 (see FIG. 20A and FIG. 20B) compared to a case of molding processing. Comparison of the third processed surface 450c resulting from push-cutting with the surface resulting from molding processing shows that in the case of push-cutting groove forming process, the force deforming the first member 410 (mixture of semi-cured material 401h and magnetic powder 402) in the first intermediate member 420 is applied unilaterally and dynamically from a blade (tool), whereas in the molding processing, the force is relatively applied isotropically and statically from a mold (tool). Therefore, in the groove forming process, the deformation level of the first member 410 reflects the distribution of the magnetic powder 402 in a more inward portion (a region farther from the tool) than a portion in the vicinity of the tool, and is thus uneven. However, due to high pressure uniformity of the entire first member 410, the deformation level of the first member 410 in the vicinity of the mold is relatively uniform in the molding processing, without being affected by the distribution of the magnetic powder 402 inside the first member 410. Therefore, the third processed surface 450c formed by the groove forming process has more processing marks M than the surface formed by the molding processing.

Since the third processed surface 450c has a relatively large number of processing marks M in this way, its surface roughness is higher than that of a molded surface formed by molding processing using a mold or the like. Therefore, adhesion of the members disposed to cover the third processed surface 450c becomes higher.

In the breaking process, processing force is applied to the workpiece in a shorter time than in the groove forming process by push-cutting. For this reason, the surface roughness of the second processed surface 450b formed by the fracture originating from the grooves G1 of the binder 403 tends to be higher than that of the third processed surface 450c. Therefore, when the first lead-out exposed surface 140 or the second lead-out exposed surface 240 is exposed from the second processed surface 450b, adhesion of the first terminal member 41 or the second terminal member 42 onto the second processed surface 450b is improved, and the conductivity between the first lead-out exposed surface 140 and the first terminal member 41, and the conductivity between the second lead-out exposed surface 240 and the second terminal member 42 can be enhanced.

FIG. 27B is a schematic cross-sectional view exemplifying a state of fracture, in which the display of the coil member 10 is omitted for ease of understanding. FIG. 27C is a schematic cross-sectional view exemplifying a state of cutting, in which the display of the coil member 10 is omitted for ease of understanding. As shown in FIG. 27B, when the third intermediate member 440 is fractured starting from the groove G1, the third intermediate member 440 is divided due to destruction of the binder 403. As a result, a state in which a part of the magnetic powder 402 is exposed from the second processed surface 450b, or a state in which the magnetic powder 402 is missing and traces indicating the presence of the magnetic powder 402 (recesses: concave portions) are formed in the second processed surface 450b, is shown. For this reason, the magnetic powder 402 located in the vicinity of the second processed surface 450b consists of unprocessed powder that does not have a cut surface. Therefore, even when the magnetic powder 402 has a portion made of a metallic material, corrosion is unlikely to occur in the vicinity of the second processed surface 450b. On the other hand, as shown in FIG. 27C, when the third intermediate member 440 is divided by cutting, not only the binder 403 included in the third intermediate member 440 but also the magnetic powder 402 is cut. Therefore, the state is such that the processing marks of the magnetic powder 402 are exposed from the fourth processed surface 450d formed by cutting processing.

### (Third Manufacturing Method)

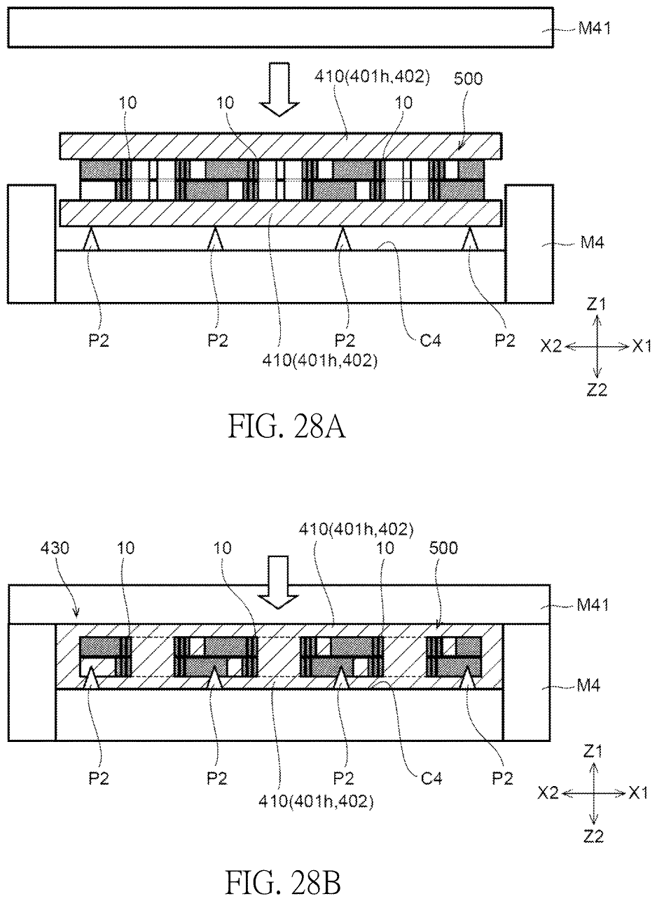

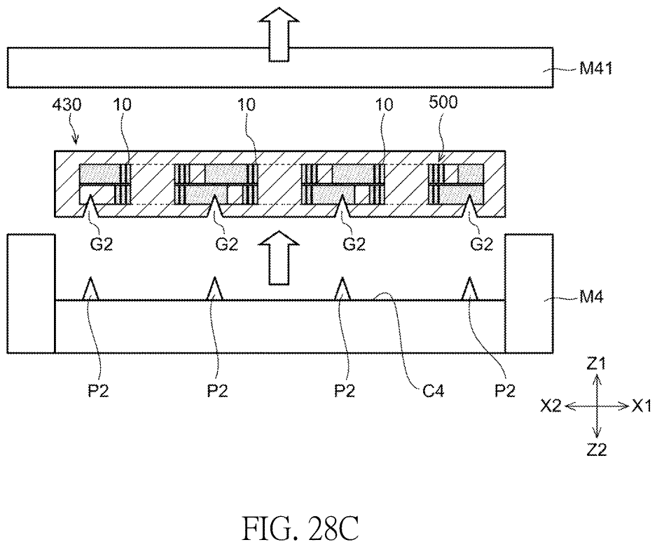

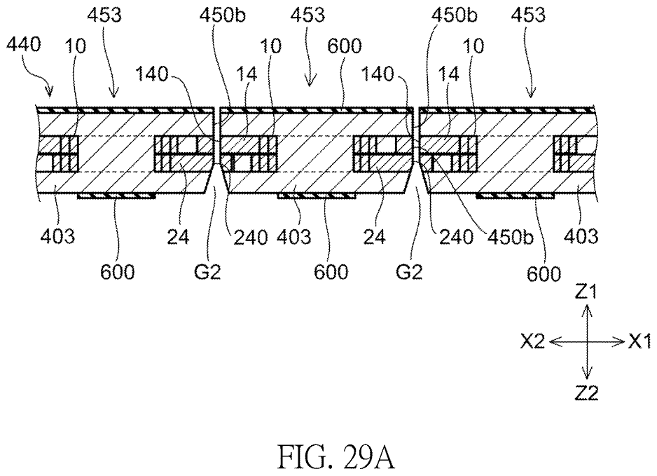

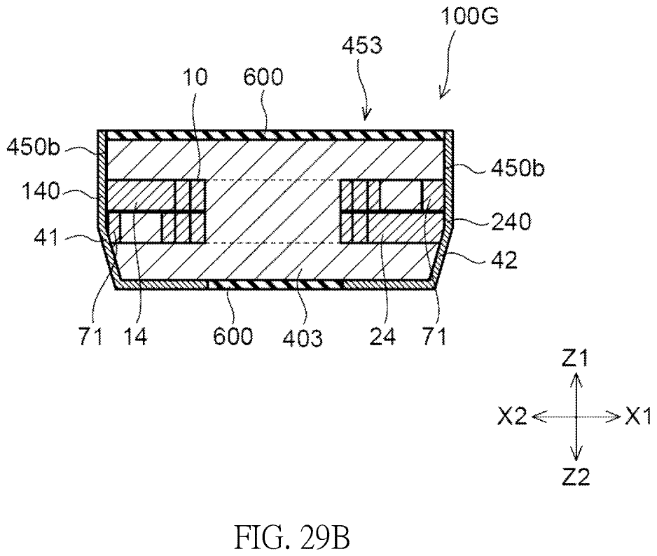

FIG. 28A to FIG. 29B are diagrams illustrating a third method for manufacturing a coil component.

The third manufacturing method is a manufacturing method performed by providing protrusions P2 on the bottom surface of the cavity C4 of the mold M4 as shown in FIG. 28A, instead of providing protrusions P1 on the upper mold M31 shown in FIG. 20A and FIG. 20B in the second manufacturing method described above.

That is, as shown in FIG. 28A, a mold M4 having protrusions P2 provided on the bottom surface of the cavity C4 is prepared, and the first member 410 and the coil members 10 are housed in the cavity C4. In the manufacturing method, a plurality of coil members 10 are included in the coil array sheet 500. The coil array sheet 500 including the coil members 10 is sandwiched between a pair of first members 410 within the cavity C4, and in this state, is pressed by an upper mold M41. The upper mold M41 is not provided with protrusions P1.

The subsequent steps are the same as the second manufacturing method, but as shown in FIG. 28B and FIG. 28C, in the third manufacturing method, the groove forming process is performed by the protrusions P2 provided in the cavity C4 of the mold M4, whereby the second intermediate member 430 having grooves G2 on the Z2 side in the Z1-Z2 direction is formed. The grooves G2 are provided in a substantially V-shape pointing toward the Z1 side in the Z1-Z2 direction.

The shape, size, and arrangement of the protrusions P2, which are the processing means for the groove forming process in this example, are set appropriately. As will be described later, when a breaking process is performed from the surface of the grooves G2 formed by the protrusions P2, the shape of the protrusions P2 is set so that the surface of the grooves G2 has a shape in which a starting point for the breaking process is easily formed.

Then, a slit forming process and a curing process similar to the slit forming process forming the slits 423 in the second manufacturing method are performed on the second intermediate member 430 to obtain a third intermediate member 440. A breaking process is performed on the third intermediate member 440, breaking from the surface where the grooves G2 are formed by the groove forming process. As a result, as shown in FIG. 29A, the third intermediate member 440 is fractured, and a second processed surface 450b including the extension direction of the groove G2 (Y1-Y2 direction) and the first direction (Z1-Z2 direction) as in-plane directions is formed on the third intermediate member 440.

The breaking process is performed by an existing snap-break method. By the breaking process, the third intermediate member 440 including a plurality of coil members 10 aligned in the X1-X2 direction is divided into pieces with individual coil members 10, and coil component materials 453 are formed. When the third intermediate member 440 is fractured, the first lead-out portion 14 and the second lead-out portion 24 of the coil member 10 are formed in the coil component material 453, and the first lead-out exposed surface 140 and the second lead-out exposed surface 240 are exposed from the second processed surface 450b.

After forming the coil component materials 453, as shown in FIG. 29B, a first terminal member 41 and a second terminal member 42 are formed on the surfaces of the coil component material 453 where the outer cover material 600 is not provided, including the second processed surfaces 450b. Since the first lead-out exposed surface 140 and the second lead-out exposed surface 240 are exposed from the second processed surfaces 450b of the coil component material 453, conduction between the coil member 10 and the first terminal member 41 and the second terminal member 42 is achieved here by way of the first terminal member 41 and the second terminal member 42 formed on the second processed surfaces 450b. Thus the coil component 100G is completed. The coil component 100G corresponds to the coil component 100A (see FIG. 5).

The coil component 100G obtained by the third manufacturing method is provided with dummy electrodes 71 similarly to the coil component 100F obtained by the second manufacturing method, but the dummy electrodes 71 may not be provided. As in the case of the second manufacturing method, it is possible to prevent the dummy electrodes 71 from being formed by changing the shape of the coil array sheet 500A or changing the processing means for obtaining the coil component material 453.

In the third manufacturing method, modifications similar to those of the second manufacturing method may also be made. That is, as shown in FIG. 24A to FIG. 25B, the curing process for curing the semi-cured material 401h to obtain the binder 403 may be performed between the groove forming process for forming the grooves G2 and the slit forming process for forming the slits 423 in the direction (X1-X2 direction) orthogonal to the extending direction (Y1-Y2 direction) of the grooves G2. Alternatively, the process for forming the first intermediate member 420 and the groove forming process for forming the second intermediate member 430 may be performed in separate steps.

As another modification example, instead of the groove forming process for forming the grooves G2, a slit forming process extending in the Y1-Y2 direction may be performed by push-cutting. In this case, a structure in which the entire outer surface 30a is the tapered outer surface 301 and the entire outer surface 30b is the tapered outer surface 302. That is, the coil component 100B (see FIG. 8) according to the second embodiment is formed. In this modification example, the slit forming process may be performed in the same step as the molding process, or alternatively, the molding process may be first performed to obtain the first intermediate member 420, and then the slit forming process may be performed on the first intermediate member 420 to obtain the second intermediate member 430.

### (Fourth Manufacturing Method)

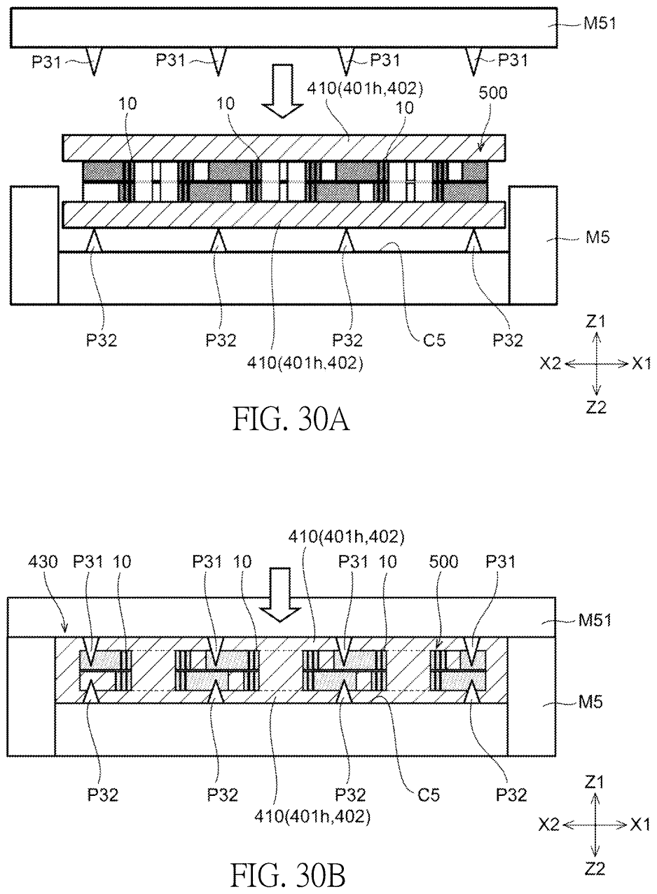

FIG. 30A to FIG. 36B are diagrams illustrating a fourth method for manufacturing a coil component.

The fourth manufacturing method is a manufacturing method performed by providing protrusions P31 on an upper mold M51 as shown in FIG. 30A, and also providing protrusions P32 on the bottom surface of a cavity C5 of a mold M5.

In the fourth manufacturing method, the process up to the formation of the coil array sheet 500 and the first member 410 is the same as the first manufacturing method.

Next, as shown in FIG. 30A and FIG. 30B, the first member 410 and the coil members 10 are housed in the cavity C5 of the mold M5. In the manufacturing method, a plurality of coil members 10 are included in the coil array sheet 500. The coil array sheet 500 including the coil members 10 is sandwiched between a pair of first members 410 within the cavity C5, and in this state, is pressed by the upper mold M51.

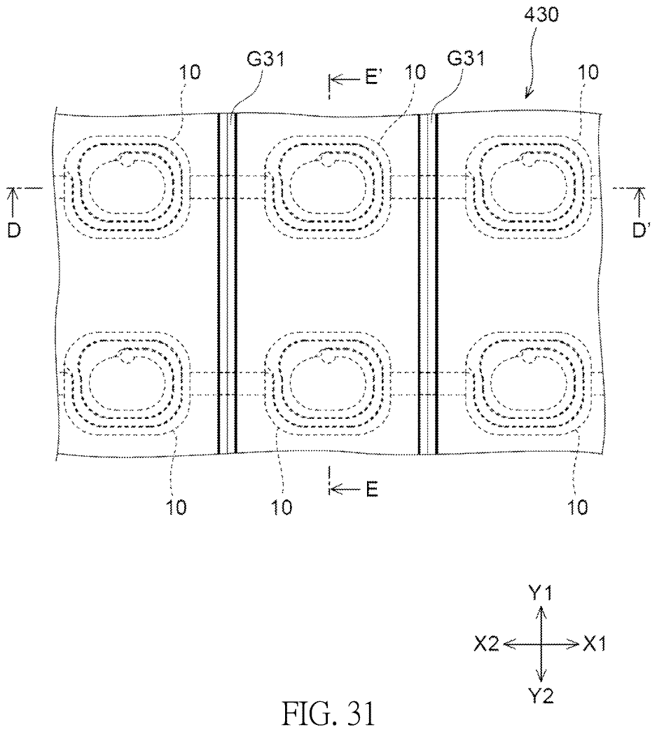

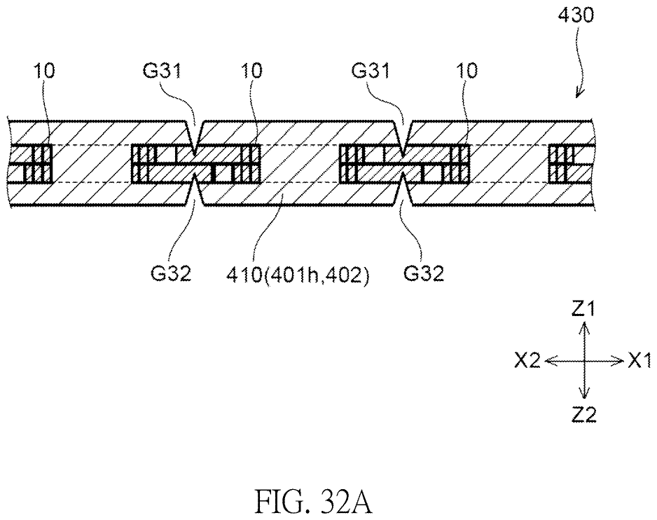

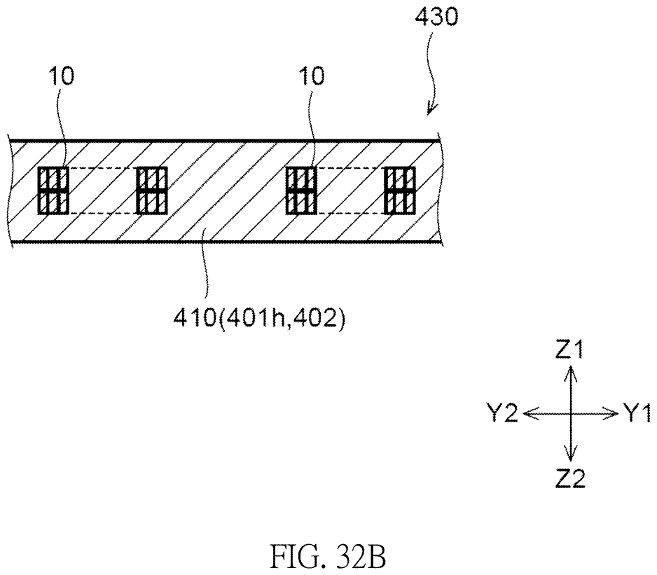

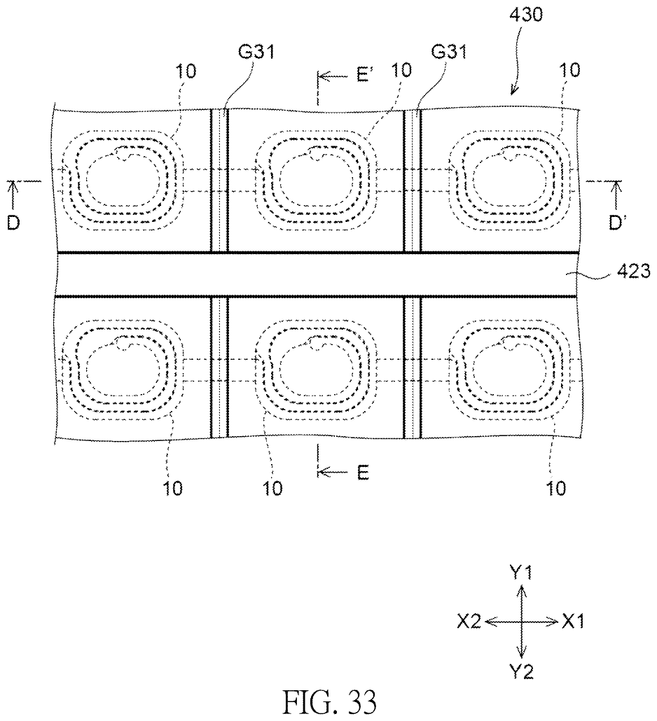

In the fourth manufacturing method, the upper mold M51 is provided with mountain-shaped protrusions P31, and the cavity C5 of the mold M5 is provided with mountain-shaped protrusions P32. The coil array sheet 500 is sandwiched between a pair of first members 410, housed in the cavity C5, and pressed by the upper mold M51, whereby the pair of first members 410 are integrated in the cavity C5, and a first intermediate member 420 in which the coil members 10 are contained in the integrated first member 410 is formed. At this time, a groove forming process is performed with the protrusions P31 and the protrusions P32 to form grooves G31 (see FIG. 31) and grooves G32 (see FIG. 32A) in the first member 410, and a second intermediate member 430 (see FIG. 31) is formed. That is, in the manufacturing method, the second intermediate member 430 is formed by performing the process of forming the first intermediate member 420 and the groove forming process in a single step.

The shape, size, and arrangement of the protrusions P31 and the protrusions P32, which are the processing means for the groove forming process in this example, are appropriately set. As will be described later, when a breaking process is performed from the surface of the grooves G31 or the surface of the grooves G32 formed by the protrusions P31 and the protrusions P32, the shape of the protrusions P31 or the protrusions P32 is set so that the surface of the grooves G31 or the surface of the grooves G32 has a shape in which a starting point for the breaking process is easily formed. In addition, the width and height of the grooves on the side that does not become the starting point of the breaking process are also set so that the second processed surface 450b can be easily formed properly.

FIG. 31 to FIG. 32B show the second intermediate member 430 having the grooves G31 and the grooves G32. FIG. 31 shows an XY plan view of the second intermediate member 430, FIG. 32A shows a cross section taken along line D-D′ in FIG. 31, and FIG. 32B shows a cross section taken along line E-E′ in FIG. 31.

The second intermediate member 430 has a substantially V-shaped groove G31 to which the shape of the protrusion P31 (see FIG. 30A and FIG. 30B) is transferred, and has a substantially V-shaped groove G32 to which the shape of the protrusion P32 (see FIG. 30A and FIG. 30B) is transferred. Since the protrusion P31 and the protrusion P32 are arranged facing each other in the Z1-Z2 direction, the groove G31 and the groove G32 formed in the second intermediate member 430 are also provided at facing positions.

The protrusions P31 and the protrusions P32 are arranged at corresponding positions in the plurality of coil members 10, and extends in one direction (specifically, Y1-Y2 direction). Accordingly, the grooves G31 and the grooves G32 are also provided extending in the one direction (specifically, Y1-Y2 direction) between the plurality of coil members 10 along the extensions of the protrusions P31 and the protrusions P32. The grooves G31 are provided on the Z1 side in the Z1-Z2 direction of the second intermediate member 430, and formed in a substantially V-shape pointing toward the Z2 side. Also, the grooves G32 are provided on the Z2 side in the Z1-Z2 direction of the second intermediate member 430, and formed in a substantially V-shape pointing toward the Z1 side.

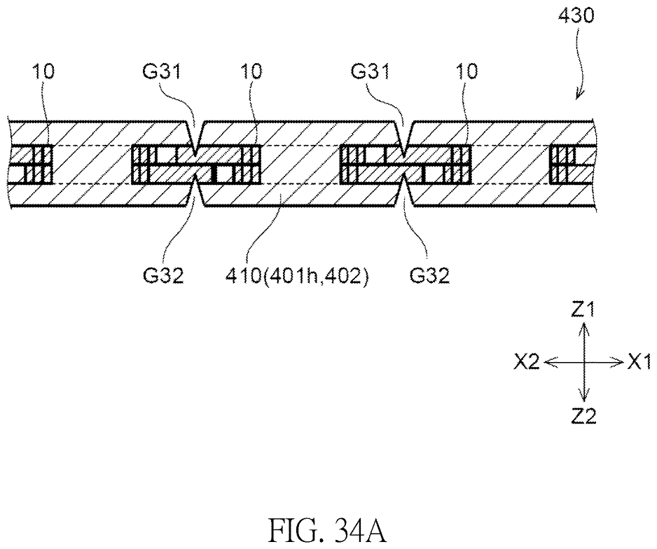

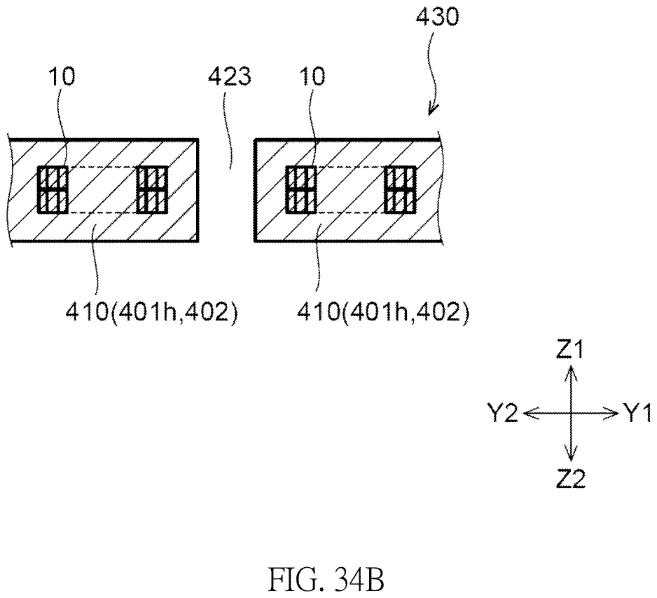

Next, as shown in FIG. 33 to FIG. 34B, a slit forming process is performed to form slits 423 in the second intermediate member 430. FIG. 33 shows an XY plan view of the second intermediate member 430, FIG. 34A shows a cross section taken along line D-D′ in FIG. 33, and FIG. 34B shows a cross section taken along line E-E′ in FIG. 33.

By the slit forming process, slits 423 are formed between the plurality of coil members 10 aligned in the Y1-Y2 direction, penetrating the second intermediate member 430 in the Z1-Z2 direction along the X1-X2 direction, and the second intermediate member 430 is divided into a plurality of pieces. The processing means for the slit forming process is arbitrary, and specific examples include push-cutting with a blade and cutting with a dicing saw. FIG. 33 and FIG. 34B show a case where cutting with a dicing saw is performed as the slit forming process. The surface formed in the slit forming process (inner side surface of the slit 423) is along the first direction (Z1-Z2 direction). By processing in this way, compared to the case where the inner side surface of the slit 423 includes a tapered surface, it is possible to increase the volume of the main body portion 30 and enhance the magnetic characteristics.

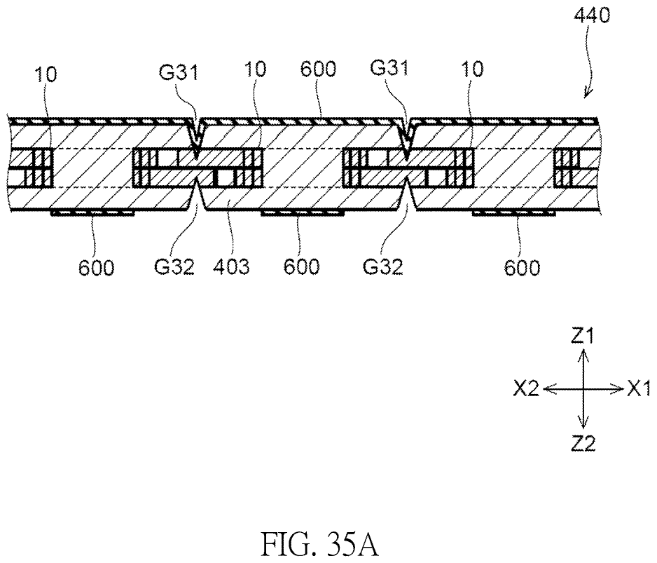

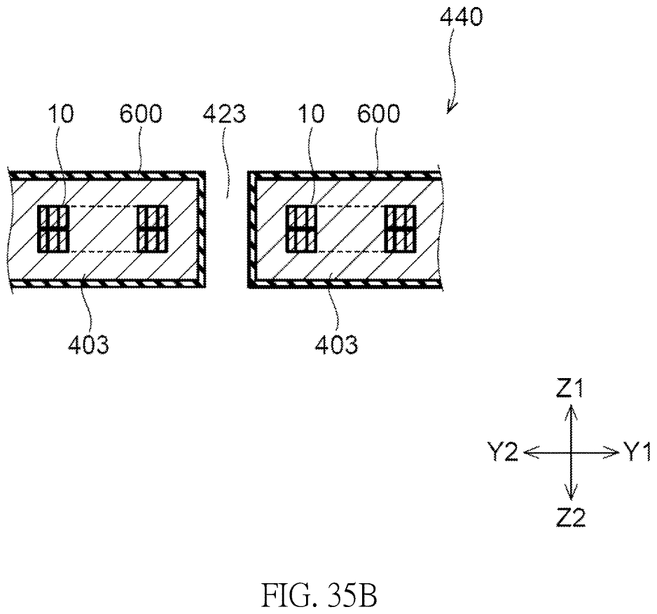

After forming the slits 423 in the second intermediate member 430, a curing process is performed to cure the semi-cured material 401h contained in the second intermediate member 430 into a binder 403 (see FIG. 35A). This forms a third intermediate member 440 (see FIG. 35A). Specific conditions for the curing process are appropriately set according to the composition and curing state of the semi-cured material 401h, and a specific example is holding at about 175° C. for 5 hours.

Next, as shown in FIG. 35A and FIG. 35B, an outer cover processing is applied to the third intermediate member 440. FIG. 35A shows a cross section of the third intermediate member 440 viewed at the same position as the line D-D′ in FIG. 33, and FIG. 35B shows a cross section of the third intermediate member 440 viewed at the same position as the line E-E′ in FIG. 33. By the outer cover processing, necessary portions of the surface of the third intermediate member 440 including the inner side surface of the slit 423 formed by the slit forming process are covered with the outer cover material 600.

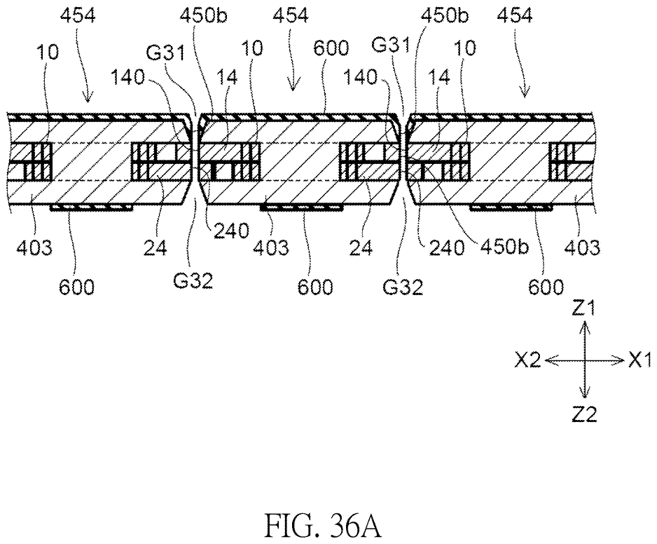

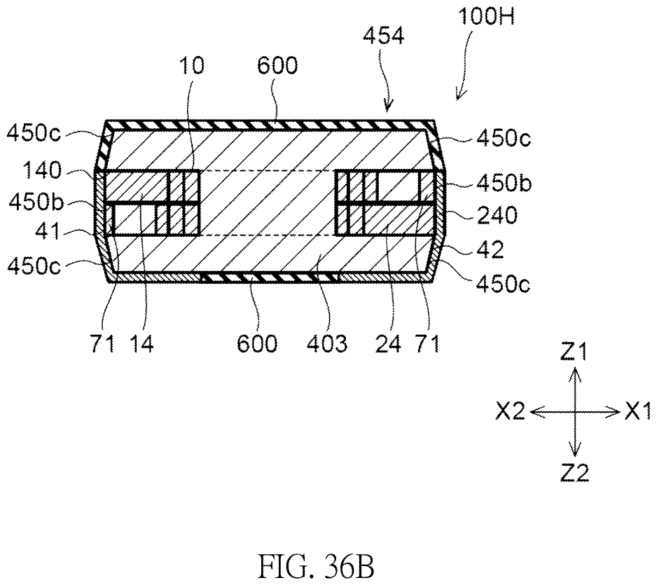

Next, the third intermediate member 440 is subjected to a breaking process in which breaking occurs from the surfaces where the grooves G31 and the grooves G32 are formed by the groove forming process (see FIG. 36A). As a result, the third intermediate member 440 is divided, and a second processed surface 450b including the extending direction of the portion of the groove G31 or the groove G32 (Y1-Y2 direction) and the first direction (Z1-Z2 direction) as in-plane directions is formed in the third intermediate member 440.

The breaking process is performed by an existing snap-break method. By the breaking process, the third intermediate member 440 having a plurality of coil members 10 arranged in the X1-X2 direction is separated into pieces with individual coil members 10, forming coil component materials 454. In the coil component material 454, when the third intermediate member 440 is broken, the first lead-out portion 14 and the second lead-out portion 24 of the coil member 10 are formed, and the first lead-out exposed surface 140 and the second lead-out exposed surface 240 are exposed from the second processed surface 450b.

After the coil component material 454 is formed, as shown in FIG. 36B, a first terminal member 41 and a second terminal member 42 are formed on the surfaces of the coil component material 454 where the outer cover material 600 is not provided, including the second processed surfaces 450b. Since the first lead-out exposed surface 140 and the second lead-out exposed surface 240 are exposed from the second processed surfaces 450b of the coil component material 454, conduction between the coil member 10 and the first terminal member 41 and the second terminal member 42 is achieved here by forming the first terminal member 41 and the second terminal member 42 on the second processed surfaces 450b. A coil component 100H is thus completed. The coil component 100H corresponds to the coil component 100C (see FIG. 9).

Note that the coil component 100H obtained by the fourth manufacturing method is provided with dummy electrodes 71 similarly to the coil component 100F obtained by the second manufacturing method, but the dummy electrodes 71 may not be provided. It is possible to prevent the dummy electrodes 71 from being formed by changing the shape of the coil array sheet 500A or by changing the processing means for obtaining the coil component material 454, as in the case of the second manufacturing method.

In the coil component 100H, the side surfaces of the grooves G31 and the grooves G32 formed by the groove forming process are formed by push-cutting with the protrusions P31 and the protrusions P32 shown in FIG. 30A and FIG. 30B. Accordingly, like the third processed surface 450c shown in FIG. 27A, they have processed surfaces relatively rich in processing marks M having a component in the first direction (Z1-Z2 direction). As described above, the third processed surface 450c containing many processing marks M is higher than the molded surface formed with a mold or the like. Therefore, adhesion of the members arranged to cover the side surfaces of the grooves G31 and the grooves G32 formed by the groove forming process increases.

In addition, in the fourth manufacturing method, since the grooves G31 and the grooves G32 are provided on both sides (Z1 side and Z2 side) of the third intermediate member 440 in the Z1-Z2 direction such that their pointed sides face each other, the direction of breakage starting from the grooves G31 and the grooves G32 is stabilized, and the breaking process can be easily and securely performed.

In the fourth manufacturing method, modifications similar to the second manufacturing method may also be possible. That is, the curing process for curing the semi-cured material 401h to obtain the binder 403 may be performed between the groove forming process for forming the grooves G31 and he grooves G32 and the slit forming process for forming the slits 423 extending in the direction (X1-X2 direction) perpendicular to the extension direction (Y1-Y2 direction) of the grooves G31 and the grooves G32. Alternatively, the process of forming the first intermediate member 420 and the groove forming process may be performed in separate steps.

### (Fifth Manufacturing Method)

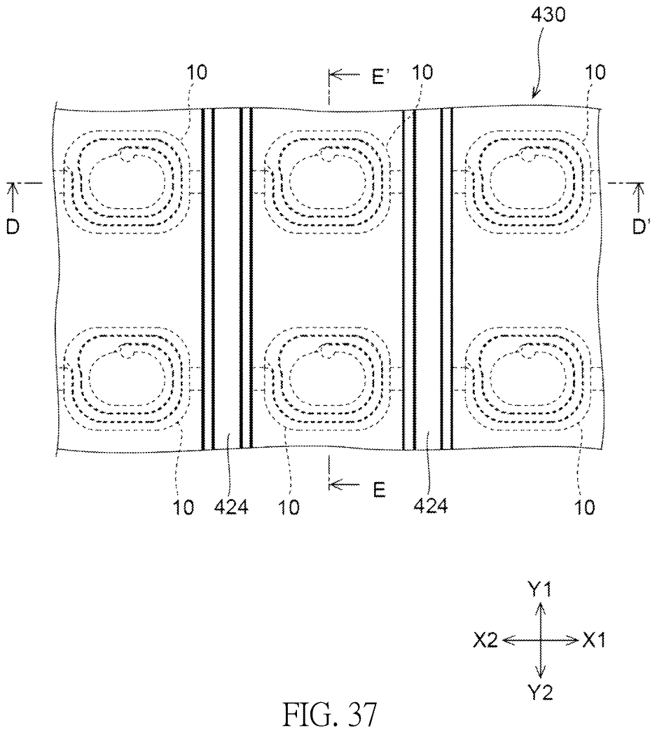

FIG. 37 to FIG. 42B are diagrams illustrating a fifth method for manufacturing a coil component.

In the fifth manufacturing method, the process up to the formation of the coil array sheet 500 and the first intermediate member 420 is the same as the first manufacturing method.

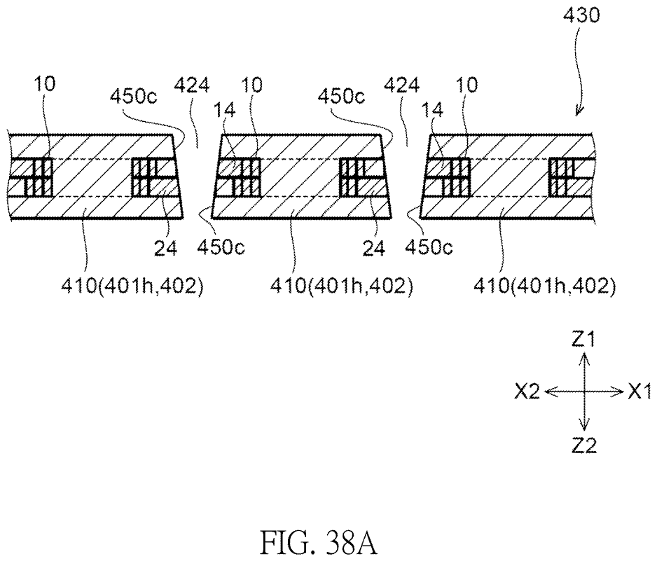

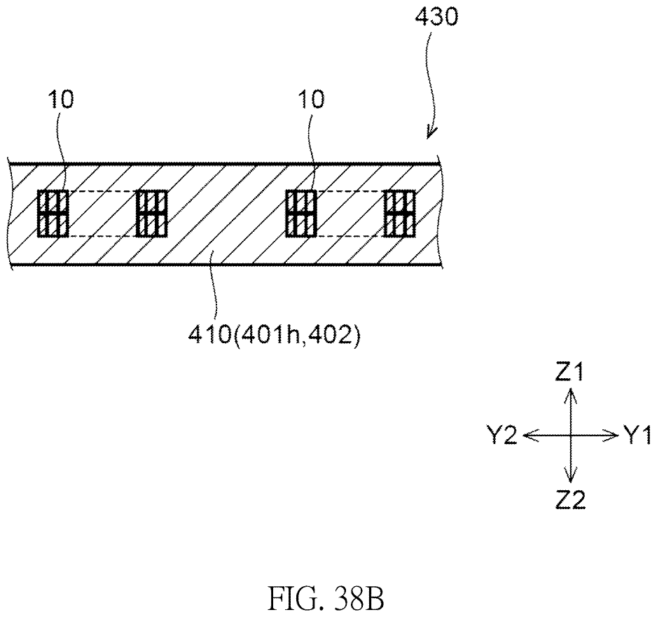

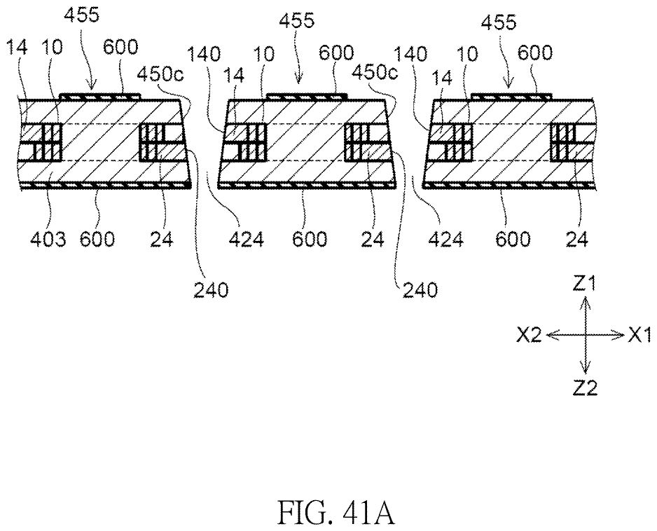

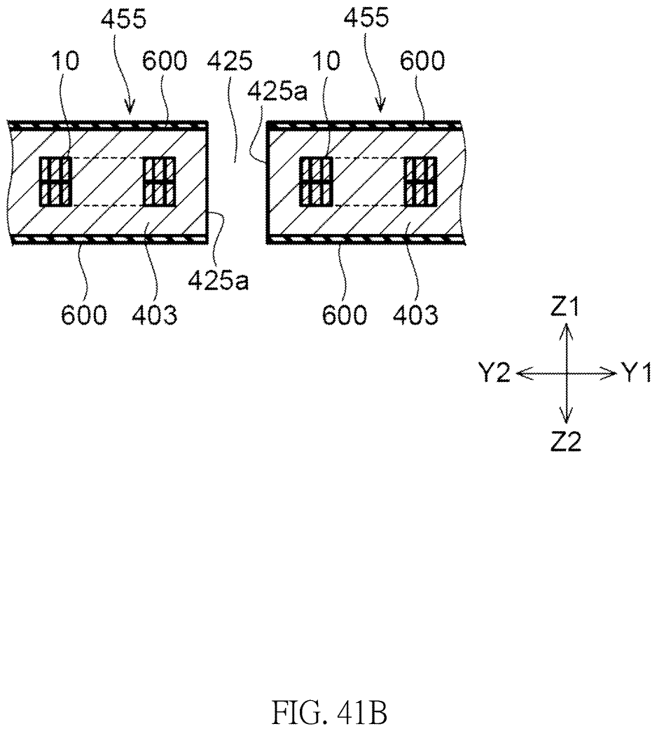

Next, as shown in FIG. 37 to FIG. 38B, a slit forming process is performed to form slits 424 in the first intermediate member 420 containing the semi-cured material 401h. FIG. 37 shows an XY plan view of the first intermediate member 420, FIG. 38A shows a cross section taken along line D-D′ in FIG. 41 (Note: reference seems to mean FIG. 37), and FIG. 38B shows a cross section taken along line E-E′ in FIG. 37.

By the slit forming process, the second intermediate member 430 is formed by dividing the first intermediate member 420 into a plurality of pieces. The processing means for the slit forming process is arbitrary, and specific examples include push-cutting with a blade and cutting with a dicing saw. In the manufacturing method, since push-cutting is performed as the slit forming process, the inner side surface of the slit 424 consists of the third processed surface 450c, and a taper is formed on the surface. Specifically, as shown in FIG. 37 and FIG. 38A, the slit 424 is provided such that its width becomes narrower from the Z1 side toward the Z2 side in the Z1-Z2 direction. By the slit forming process, the first lead-out portion 14 and the second lead-out portion 24 of the coil member 10 are formed, and the first lead-out exposed surface 140 and the second lead-out exposed surface 240 are exposed from the third processed surface 450c.

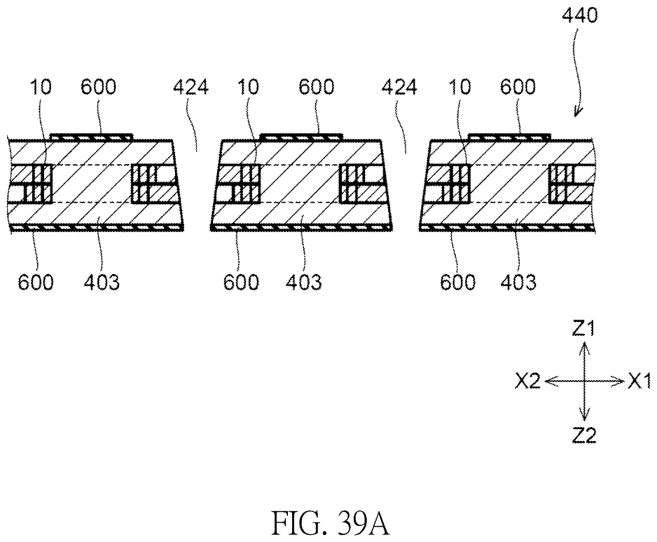

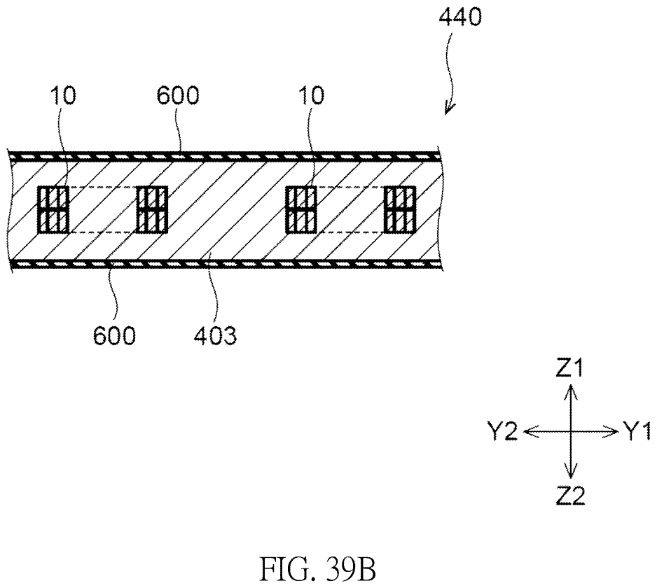

After the second intermediate member 430 is formed, a curing process is performed to cure the semi-cured material 401h included in the second intermediate member 430 into a binder 403 (see FIG. 39A). As a result, a third intermediate member 440 (see FIG. 39A) is formed. The specific conditions for the curing process are appropriately set according to the composition and curing state of the semi-cured material 401h, and a specific example is holding at about 175° C. for 5 hours.

Next, as shown in FIG. 39A and FIG. 39B, an outer cover processing is applied to the third intermediate member 440. FIG. 39A shows a cross section of the third intermediate member 440 viewed at the same position as the line D-D′ in FIG. 37, and FIG. 39B shows a cross section of the third intermediate member 440 viewed at the same position as the line E-E′ in FIG. 37. By the outer cover processing, necessary portions of the surface of the third intermediate member 440 are covered with the outer cover material 600. In the present manufacturing method, unlike the other manufacturing methods, the inner side surface of the slit 424 formed by the slit forming process is not covered with the outer cover material 600.

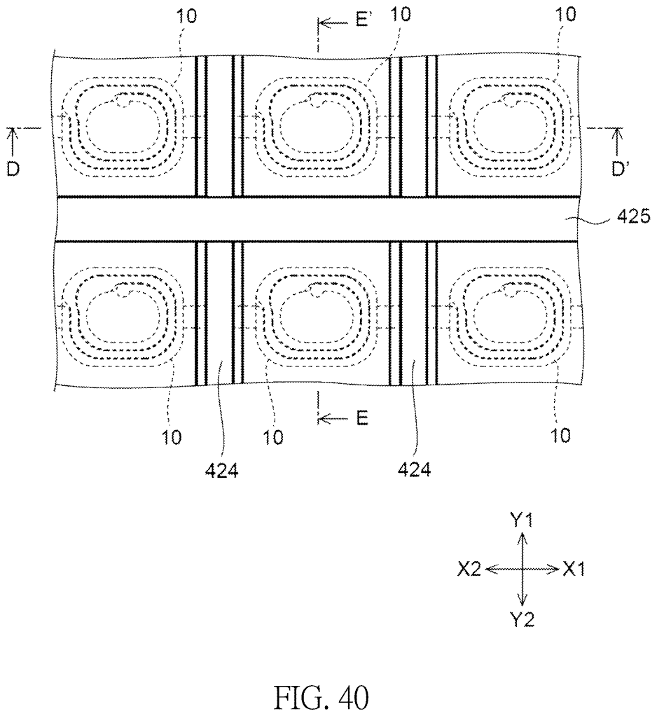

Next, as shown in FIG. 40 to FIG. 41B, the third intermediate member 440 (see FIG. 39A) is divided into individual pieces to form coil component materials 455. FIG. 40 shows an XY plan view after the third intermediate member 440 shown in FIG. 39A is separated into pieces, FIG. 41A shows a cross section taken along line D-D′ in FIG. 40, and FIG. 41B shows a cross section taken along line E-E′ in FIG. 40.

By the dividing process, slits 425 are formed between the plurality of coil members 10 arranged in the Y1-Y2 direction, penetrating the third intermediate member 440 in the Z1-Z2 direction along the X1-X2 direction. The specific processing means for the dividing process is arbitrary, and specific examples include push-cutting with a blade and cutting with a dicing saw. FIG. 40 and FIG. 41B show a case where cutting with a dicing saw is performed as the slit forming process. The surface formed by the slit forming process (the inner side surface 425a of the slit 425) is along the first direction (Z1-Z2 direction). By processing in this way, compared to the case where the inner side surface 425a of the slit 425 includes a tapered surface, it is possible to increase the volume of the main body portion 30 and enhance the magnetic characteristics.

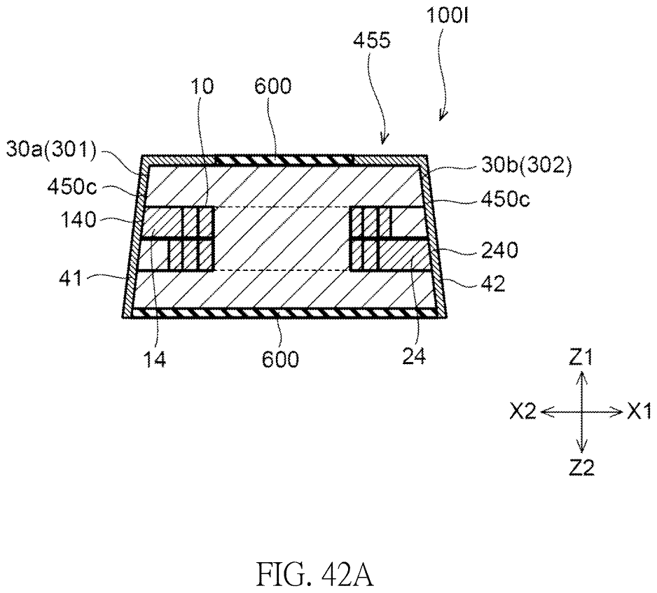

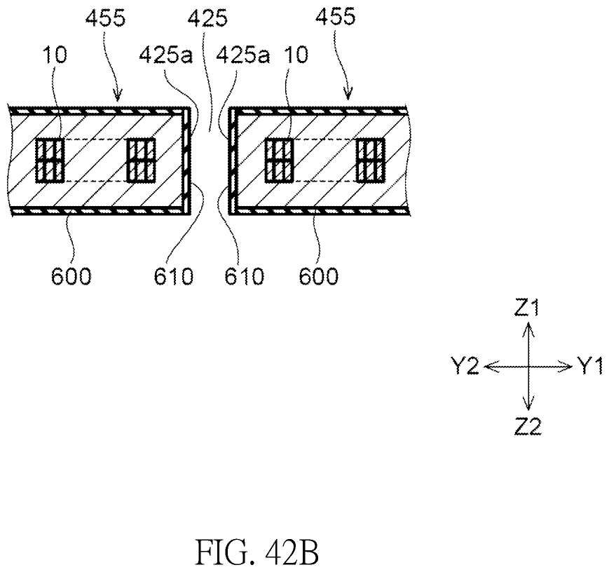

After the coil component materials 455 are formed, as shown in FIG. 42A, a first terminal member 41 and a second terminal member 42 are formed on the surfaces of the coil component material 455 where the outer cover material 600 is not provided, including the third processed surfaces 450c. Since the first lead-out exposed surface 140 and the second lead-out exposed surface 240 are exposed from the third processed surfaces 450c of the coil component material 455, conduction between the coil member 10 and the first terminal member 41 and the second terminal member 42 is performed by forming the first terminal member 41 and the second terminal member 42 on the third processed surfaces 450c. A coil component 1001 is thus completed. In the coil component 1001, similarly to the coil component 100B (see FIG. 8), the entire outer surface 30a of the main body portion 30 is a tapered outer surface 301, and the entire outer surface 30b is a tapered outer surface 302.

In the coil component 1001, as shown in FIG. 42B, an outer cover material 610 may be formed on the inner side surface 425a of the slit 425.

In the coil component 1001, the third processed surface 450c formed by cutting the first intermediate member 420 becomes the tapered outer surfaces 301, 302 (see FIG. 2), so the side toward which the taper of the third processed surface 450c approaches the center (specifically, the Z1 side in the Z1-Z2 direction) becomes the mounting surface side. Therefore, the bottom surface portion 41b of the first terminal member 41 and the bottom surface portion 42b of the second terminal member 42 are provided on the Z1 side. The arrangement relationship is reversed in the Z1-Z2 direction with respect to the coil component 100B according to the second embodiment (see FIG. 8).

In this manufacturing method, if the cutting processing for cutting the first intermediate member 420 is performed from the opposite side (Z2 side in Z1-Z2 direction), the inclination of the tapered third processed surface 450c is opposite to the above, so the Z2 side in the Z1-Z2 direction becomes the mounting surface side. In this case, the bottom surface portion 41b of the first terminal member 41 and the bottom surface portion 42b of the second terminal member 42 are provided on the Z2 side, and the resulting coil component 1001 has the same arrangement relationship as the coil component 100B (see FIG. 8) according to the second embodiment.

As described above, in the manufacturing methods according to the present embodiments (first manufacturing method to fifth manufacturing method), after obtaining the second intermediate member 430 by performing at least one of the slit forming process and the groove forming process on the first intermediate member 420 containing the semi-cured material 401h which is relatively soft compared to the binder 403, the curing process for curing the semi-cured material 401h of the second intermediate member 430 is performed. Therefore, the processing load is reduced compared to the case where the slit forming process and/or the groove forming process is performed on the third intermediate member 440 containing the binder 403. Thereby, improvement in productivity of the coil components 100A to 100I, such as extension of tool life, is realized.

Further, when performing the slit forming process by push-cutting on the first intermediate member 420 containing the semi-cured material 401h (the second manufacturing method to the fifth manufacturing method), the magnetic powder 402 tends to move away from the blade due to plastic deformation of the semi-cured material 401h. Therefore, processing marks (cut surfaces) are less likely to be generated on the magnetic powder 402 located on the third processed surface 450c formed by push-cutting. When the magnetic powder 402 does not have processing marks, corrosion is less likely to occur even if the magnetic powder 402 has a portion made of a metallic material. Therefore, the magnetic properties of the main body portion 30 containing the magnetic powder 402 are less likely to change over time.

Furthermore, when the member including the binder 403 (the third intermediate member 440) is divided by the breaking process (the second manufacturing method to the fourth manufacturing method), the magnetic powder 402 is not cut during breaking, so the magnetic powder 402 located on the second processed surface 450b formed by the breaking process is less likely to have processing marks (cut surfaces) similarly to the magnetic powder 402 located on the third processed surface 450c.

Although the present embodiment has been described above, the present invention is not limited to these examples. For example, regarding the material of each part, a material other than those described above is applicable as long as it provides the same operations and effects as the present invention. Moreover, those obtained by suitably adding, omitting, or modifying the design of the constituent elements, or suitably combining the features of the respective configuration examples by those skilled in the art with respect to each of the above-described embodiments are also included in the scope of the present invention as long as they provide the essence of the present invention.

What is claimed is:

1. A coil component, comprising:
a coil member including an annular conductor portion, which has a central axis along a first direction and includes two electrical ends; and
a main body portion covering the annular conductor portion with a first intersecting surface and a second intersecting surface aligned in the first direction, and including a binder and a magnetic powder held by the binder,
wherein the coil member is characterized in comprising:
a first end surface exposed from a surface of the main body portion and connected to one of the two electrical ends of the annular conductor portion; and
a second end surface exposed from the surface of the main body portion and connected to the other of the two electrical ends of the annular conductor portion,
wherein,
the first end surface is covered with a first external electrode having a portion provided on the second intersecting surface,
the second end surface is covered with a second external electrode, which is electrically separated from the first external electrode outside the main body portion, and has a portion provided on the second intersecting surface, and
an outer surface located between the first intersecting surface and the second intersecting surface of the main body portion has a tapered outer surface that moves away from the central axis while approaching the first intersecting surface.

2. The coil component according to claim 1, wherein each of the first external electrode and the second external electrode extends so as to at least partially cover the tapered outer surface.

3. The coil component according to claim 1, wherein the tapered outer surface includes a most distal portion located farthest from the central axis in the main body portion.

4. The coil component according to claim 3, wherein a surface roughness of the most distal portion is greater than a surface roughness of other portions on the tapered outer surface, and each of the first external electrode and the second external electrode extends so as to at least partially cover the most distal portion.

5. The coil component according to claim 1, wherein at least one of the first end surface and the second end surface includes a portion exposed from the tapered outer surface.

6. The coil component according to claim 1, wherein,
the first end surface is at least partially exposed from the second intersecting surface, and
the second end surface is at least partially exposed from a portion of the second intersecting surface different from a portion where the first end surface is at least partially exposed.

7. The coil component according to claim 1, wherein the tapered outer surface includes a portion formed from a surface relatively rich in processing marks in the first direction.

8. The coil component according to claim 7, wherein,
the magnetic powder is made of a metallic material, and
a cut surface of the magnetic powder is not located on the surface relatively rich in processing marks in the first direction.

9. A coil component comprising:
a coil member including an annular conductor portion, which has a central axis along a first direction and includes two electrical ends; and
a main body portion covering the annular conductor portion with a first intersecting surface and a second intersecting surface aligned in the first direction, and including a magnetic powder having a portion made of a metallic material, and a binder,
wherein the coil member is characterized in that:
an outer surface located between the first intersecting surface and the second intersecting surface of the main body portion has a surface relatively rich in processing marks having a component in the first direction, and
a cut surface of the magnetic powder is not located on the surface relatively rich in processing marks in the first direction.

10. The coil component according to claim 9, wherein the binder includes a cured material of a curable resin.

11. The coil component according to claim 9, wherein the magnetic powder is subjected to a surface insulation treatment.

12. A method for manufacturing a coil component,
the coil component comprising:
a coil member including an annular conductor portion, which has a central axis along a first direction and includes two electrical ends, and
a main body portion covering the annular conductor portion with a first intersecting surface and a second intersecting surface aligned in the first direction, and including a binder and a magnetic powder held by the binder,
the method being characterized in comprising:
forming a first intermediate member including a first member containing a semi-cured material of the binder and the magnetic powder, and the coil member having a portion embedded in the first member;
performing at least one of a slit forming process and a groove forming process on the first intermediate member to form a second intermediate member; and
forming a third intermediate member, which includes performing a curing process to cure the semi-cured material included in the second intermediate member into the binder.

13. The method for manufacturing the coil component according to claim 12, wherein,
the second intermediate member is formed by performing at least the groove forming process on the first intermediate member, and
a breaking process of breaking from a surface formed by the groove forming process is performed on the third intermediate member.

14. The method for manufacturing the coil component according to claim 13, wherein the second intermediate member is formed by performing the slit forming process and the groove forming process on the first intermediate member.

15. The method for manufacturing the coil component according to claim 13, wherein the breaking process is performed after the slit forming process is performed on the third intermediate member.

16. The method for manufacturing the coil component according to claim 13, wherein the first member and one or more of the coil members are placed in a cavity of a mold provided with at least one of a tool for performing the slit forming process and a tool for performing the groove forming process, and a processing to form the first intermediate member and at least one of the slit forming process and the groove forming process are performed in a single step to form the second intermediate member.

17. The method for manufacturing the coil component according to claim 12, wherein the second intermediate member is formed by performing the slit forming process on the first intermediate member, and the slit forming process is performed on the third intermediate member.

18. The method for manufacturing the coil component according to claim 14, wherein a processing to divide the third intermediate member is performed after an outer cover processing is applied to the third intermediate member.

19. The method for manufacturing the coil component according to claim 12, wherein in the groove forming process, the processing is performed from both a side corresponding to the first intersecting surface and a side corresponding to the second intersecting surface of the first intermediate member.

20. The method for manufacturing the coil component according to claim 12, wherein a processing to divide the third intermediate member is performed, and an outer cover processing is performed to apply an outer cover to a member obtained by the processing.
